(19) United States
(12) Patent Application Publication
(10) Pub. No.: US 2026/0018940 A1
(43) Pub. Date: Jan. 15, 2026

(54) DYNAMIC SELECTION OF WIRELESS POWER DISTRIBUTION MODALITIES

(71) Applicant: Sonos, Inc., Goleta, CA (US)

(72) Inventor: Joern Riemer, Trabuco Canyon, CA (US)

(21) Appl. No.: 19/262,388

(22) Filed: Jul. 8, 2025

Related U.S. Application Data
(60) Provisional application No. 63/669,945, filed on Jul. 11, 2024.

(51) Int. Cl. H02J 50/80; H02J 50/00; H02J 50/12; H02J 50/20; H02J 50/30; H02J 50/40

(52) U.S. Cl. CPC H02J 50/80; H02J 50/001; H02J 50/005; H02J 50/402; H02J 50/12; H02J 50/20; H02J 50/30; H02J 2310/14

(57) ABSTRACT

A wireless charging device capable of charging compatible devices via multiple power transmission modalities is disclosed. The wireless charging device comprises multiple power transmitters, each capable of transmitting power to a device via one or more power transmission modalities. After detecting the presence of a compatible device or a change it the compatible device's position, the wireless charging device configures the appropriate power transmitter for power transmission to the compatible device. Additionally, the wireless charging device can send playback settings to the compatible device to accommodate changes in the power transmission modality to, for example, reduce power consumption of the compatible device.

### CROSS-REFERENCE TO RELATED APPLICATION

This application claims the benefit of priority to U.S. Patent Application Publication No. 63/669,945, filed Jul. 11, 2024, which is herein incorporated by reference in its entirety.

### FIELD OF THE DISCLOSURE

The present disclosure is related to consumer goods and, more particularly, to methods, systems, products, features, services, and other elements directed to power distribution and/or harvesting involving media playback devices and aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A shows a partial cutaway view of an environment having a media playback system configured in accordance with aspects of the disclosed technology.

FIG. 1B shows a schematic diagram of the media playback system of FIG. 1A and one or more networks.

FIG. 1C shows a block diagram of a playback device.

FIG. 1D shows a block diagram of a playback device.

FIG. 1E shows a block diagram of a network microphone device.

FIG. 1F shows a block diagram of a network microphone device.

FIG. 1G shows a block diagram of a playback device.

FIG. 1H shows a partially schematic diagram of a control device.

FIGS. 1I through 1L show schematic diagrams of corresponding media playback system zones.

FIG. 1M shows a schematic diagram of media playback system areas.

FIG. 2A shows a front isometric view of a playback device configured in accordance with aspects of the disclosed technology.

FIG. 2B shows a front isometric view of the playback device of FIG. 3A without a grille.

FIG. 2C shows an exploded view of the playback device of FIG. 2A.

FIG. 2D is a diagram of another example housing for a playback device.

FIG. 2E is a diagram of another example housing for a playback device.

FIG. 3A shows a front view of a network microphone device configured in accordance with aspects of the disclosed technology.

FIG. 3B shows a side isometric view of the network microphone device of FIG. 3A.

FIG. 3C shows an exploded view of the network microphone device of FIGS. 3A and 3B.

FIG. 3D shows an enlarged view of a portion of FIG. 3B.

FIG. 3E shows a block diagram of the network microphone device of FIGS. 3A-3D.

FIG. 3F shows a schematic diagram of an example voice input.

FIGS. 4A-4D show schematic diagrams of a control device in various stages of operation in accordance with aspects of the disclosed technology.

FIG. 5 shows front view of a control device.

FIG. 6 shows a message flow diagram of a media playback system.

FIG. 7 shows an example configuration of a wireless charging device in accordance with the disclosed technology.

FIG. 8 shows a device configured to be charged via multiple power transmission modalities in accordance with the disclosed technology.

FIG. 9 illustrates a method for configuring a wireless charging device to transmit power to a compatible device via an appropriate power transmission modality in accordance with the disclosed technology.

FIG. 10 illustrates a method for configuring a wireless charging device to transmit power to a compatible device via an appropriate power transmission modality in accordance with the disclosed technology.

FIG. 11 illustrates a method for transmitting device settings to a compatible device based on a determined power transmission modality in accordance with the disclosed technology.

FIG. 12 illustrates several configurations for charging a compatible device using a wireless charging device with multiple power transmitters, each configured transmitter power via one or more power transmission modalities in accordance with the disclosed technology.

FIG. 13 is a partially schematic diagram illustrating a charging device that is integrated into another device in accordance with the disclosed technology.

FIGS. 14A-14D are partially schematic diagrams of a side view of a playback device positioned in a listening environment in accordance with the disclosed technology.

FIGS. 15A-15C are schematic diagrams of a first playback device and a second playback device capable of transmitting and/or receiving wireless power in accordance with the disclosed technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Many modern wearable and portable devices have energy storage (e.g., batteries) that are capable of being wirelessly recharged. For example, a portable device, such as a portable playback device or wearable device (e.g., headphones) may be placed on or near a wireless charging device (e.g., a power-delivering device, such as a near-field charging device such as a QI® or REZENCE® charging pad or headphone base/case/stand, etc.). As another example, in-car earbuds may be placed in a corresponding charging case to charge their batteries. However, when the device is being wirelessly charged via a near-field charging device, it is typically not available to be moved (without terminating the charging of the device) or worn because the headphone stand and/or charging case have a limited range. For example, QI® charging devices are only effective over distances up to approximately 1.6 in (4 cm) while REZENCE® charging devices are effective up to approximately 2 in (5 cm). Moreover, when the device runs out of energy (i.e., when the batteries are discharged), the device will need to be returned to its charging stand, case, etc. or plugged into a wired charging device. As an alternative to near-field charging devices, far-field charging devices allow devices to be charged over longer distances via, for example, optical (e.g., infrared, visible, ultraviolet) electromagnetic transmission, WiFi transmission, radio frequency (RF) transmission, magnetic resonance, ultrasound, thermal energy transmission, or any other suitable wireless power transmission technique. For example, far-field wireless power systems, such as the COTA® REAL WIRELESS POWER system from OSSIA®, can provide power up to 30 feet from a corresponding hub. Moreover, some of these systems can provide power through walls or other objects. However, far-field charging devices tend to be less efficient than near-field charging devices and, in some cases, require significant hardware investments.

To address these and other problems, the inventors have conceived of a wireless charging device capable of providing power to compatible devices (e.g., a power-receiving device, such as a device comprising one or more power receivers compatible with the power transmitters of the wireless charging device) via multiple modalities. In some examples, for instance, in a first mode, the wireless charging device provides power to devices via an in-contact or near-field power transmission modality. In these scenarios, the wireless charging device can also provide power to devices via a far-field power transmission modality in a second mode, and, perhaps, via a wired or physical connection in a third mode. Thus, the wireless charging device can be configured to power devices using the most efficient modality available to the wireless charging device and corresponding device(s). Accordingly, the disclosed wireless charging device provides significant advantages over conventional charging devices.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

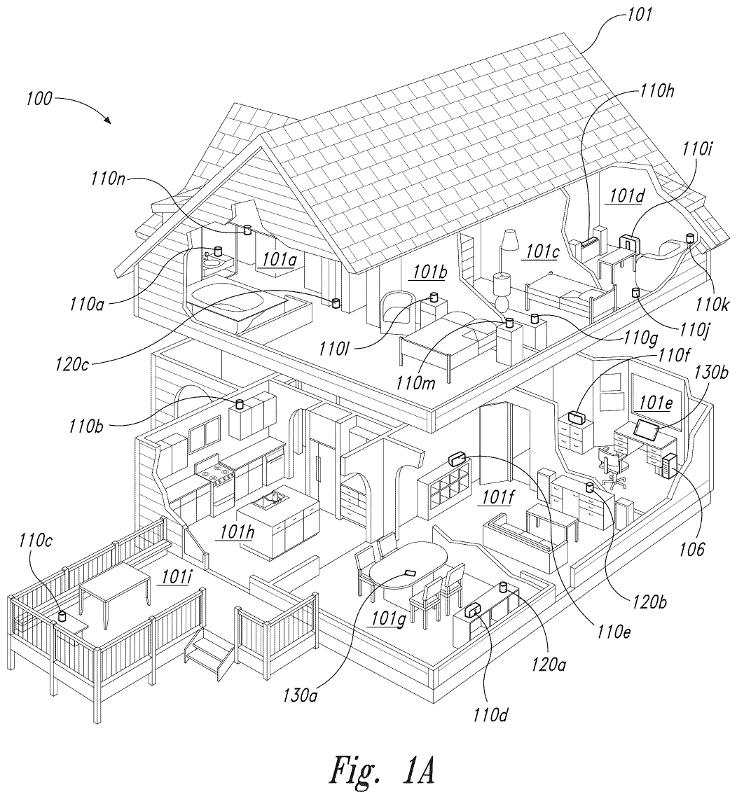

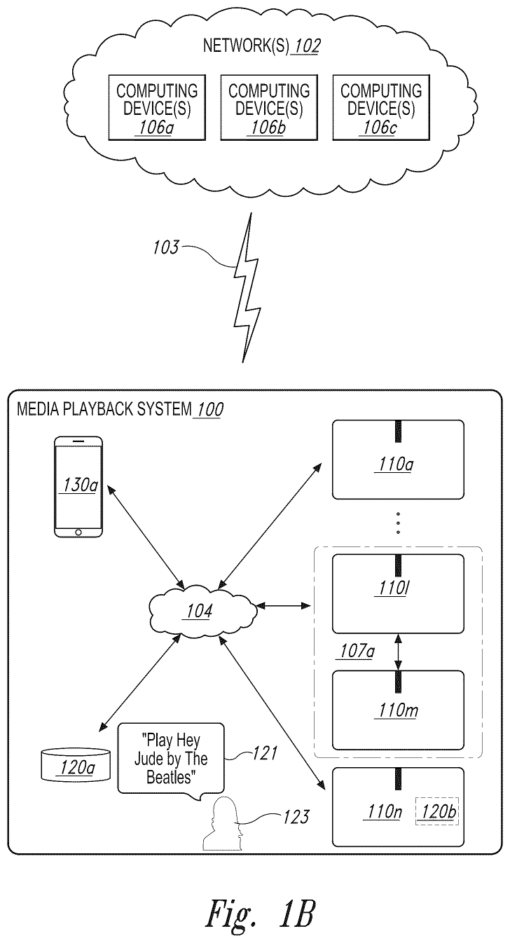

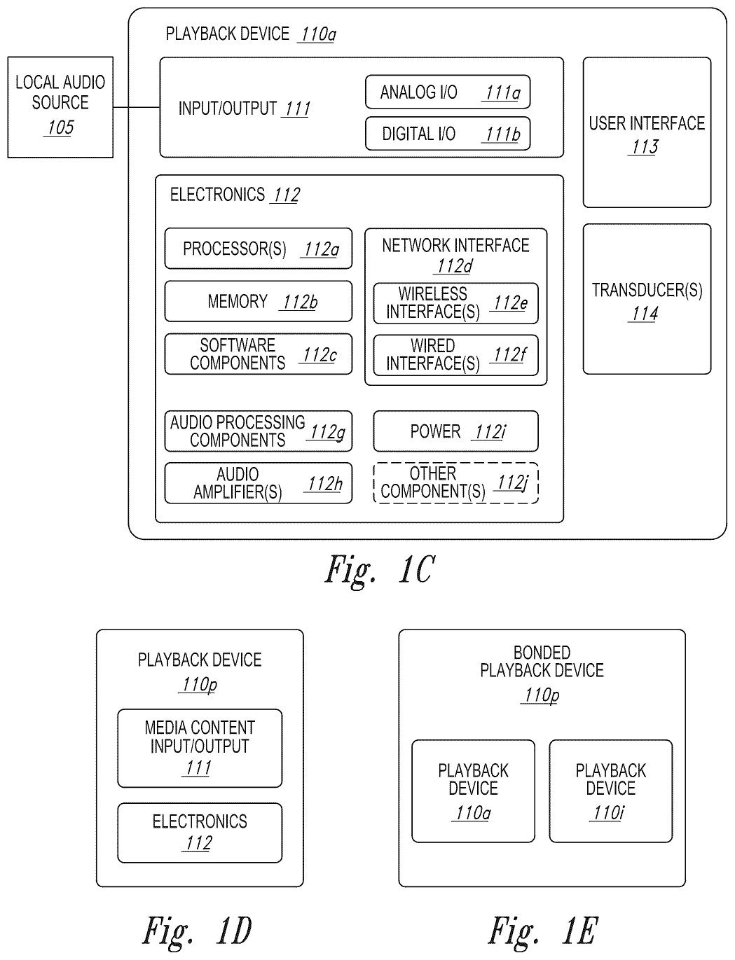

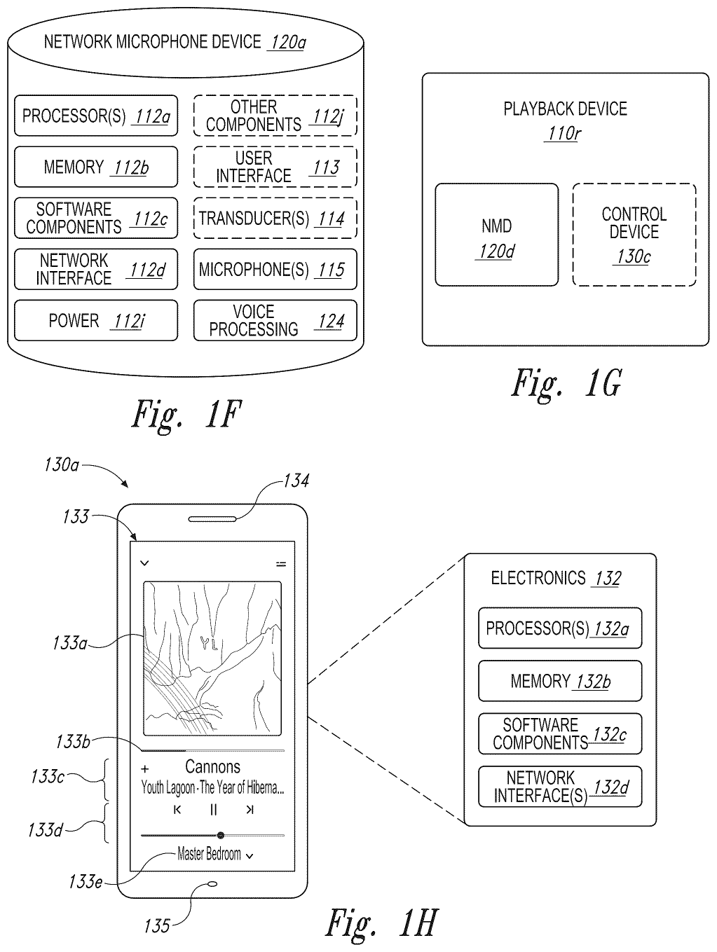

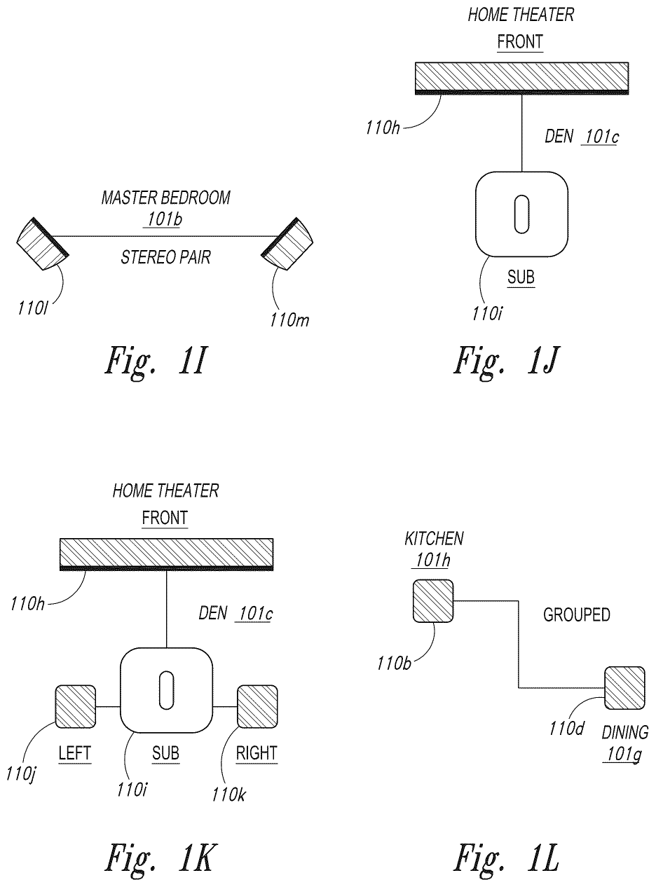

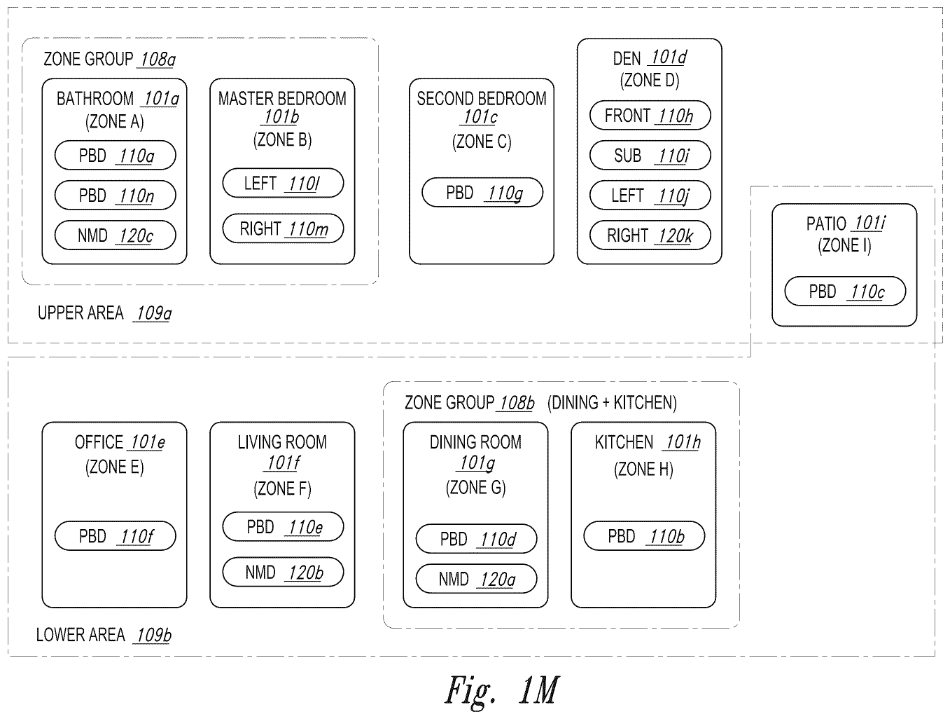

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-IL.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the patio 101i. In some aspects, a single playback zone may include multiple rooms or spaces. In certain aspects, a single room or space may include multiple playback zones.

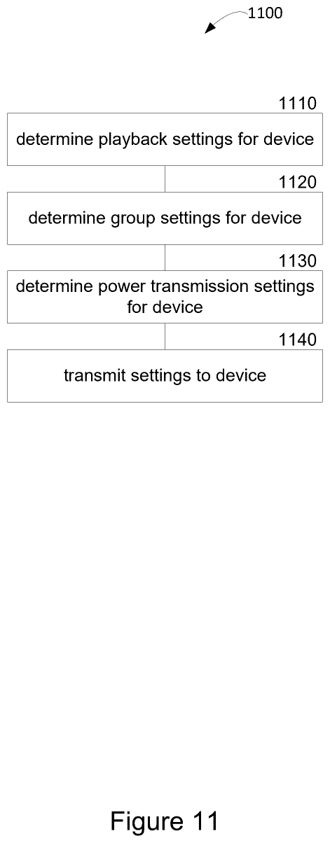

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to, for example, FIGS. 1B and 1E and 11-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and Method for Synchronizing Operations Among a Plurality of Independently Clocked Digital Data Processing Devices,” which is incorporated herein by reference in its entirety.

To facilitate synchronous playback, the playback device(s) described herein may, in some embodiments, be configurable to operate in (and/or switch between) different modes such as an audio playback group coordinator mode and/or an audio playback group member mode. While operating in the audio playback group coordinator mode, the playback device may be configured to coordinate playback within the group by, for example, performing one or more of the following functions: (i) receiving audio content from an audio source, (ii) using a clock (e.g., a physical clock or a virtual clock) in the playback device to generate playback timing information for the audio content, (iii) transmitting portions of the audio content and playback timing for the portions of the audio content to at least one other playback device (e.g., at least one other playback device operating in an audio playback group member mode), (iv) transmitting timing information (e.g., generated using the clock to the at least one other playback device; and/or (v) playing back the audio content in synchrony with the at least one other playback device using the generated playback timing information and/or the clock. While operating in the audio playback group member mode, the playback device may be configured to perform one or more of the following functions: (i) receiving audio content and playback timing for the audio content from the at least one other device (e.g., a playback device operating in an audio playback group coordinator mode); (ii) receiving timing information from the at least one other device (e.g., a playback device operating in an audio playback group coordinator mode); and/or (iii) playing the audio content in synchrony with at least the other playback device using the playback timing for the audio content and/or the timing information.

a. Suitable Media Playback System

FIG. 1B is a schematic diagram of the media playback system 100 and a cloud network 102. For case of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN) (e.g., the Internet), one or more local area networks (LAN) (e.g., one or more WIFI networks), one or more personal area networks (PAN) (e.g., one or more BLUETOOTH networks, Z-WAVE networks, wireless Universal Serial Bus (USB) networks, ZIGBEE networks, and/or IRDA networks), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11 g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct or indirect connections, PANs, LANs, telecommunication networks, and/or other suitable communication links.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1-I through M.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) transmit a corresponding command to the media playback system 100. In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

As described in more detail elsewhere herein, in some examples the power components 112i can include one or more of: a wireless power transmitter (e.g., a laser, induction coils, etc.), a wireless power receiver (e.g., a photovoltaic cell, induction coils, etc.), an energy storage component (e.g., a capacitor, a rechargeable battery), an energy harvester, a wired power input port, and/or associated power circuitry. In operation, the playback device 110a can be configured to transmit wireless power to one or more external devices. Additionally or alternatively, the playback device 110a can be configured to receive wireless power from one or more external transmitter devices, instead of or in addition to receiving power over a wired connection.

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio information from an audio source (e.g., one or more of the computing devices 106a-c (FIG. 1B)), and/or another one of the playback devices 110. In some embodiments, the operations further include causing the playback device 110a to send audio information to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-car earphones). The headphone may comprise a headband coupled to one or more carcups. For example, a first carcup may be coupled to a first end of the headband and a second carcup may be coupled to a second end of the headband that is opposite the first end. Each of the one or more carcups may house any portion of the electronic components in the playback device, such as one or more transducers. Further, the one or more of carcups may include a user interface for controlling operation of the headphone such as for controlling audio playback, volume level, and other functions. The user interface may include any of a variety of control elements such as buttons, knobs, dials, touch-sensitive surfaces, and/or touchscreens. An car cushion may be coupled each of the one or more carcups. The car cushions may provide a soft barrier between the head of a user and the one or more carcups to improve user comfort and/or provide acoustic isolation from the ambient (e.g., provide passive noise reduction (PNR)). Additionally (or alternatively), the headphone may employ active noise reduction (ANR) techniques to further reduce the user's perception of outside noise during playback.

In some instances, the headphone device may take the form of a hearable device. Hearable devices may include those headphone devices (e.g., car-level devices) that are configured to provide a hearing enhancement function while also supporting playback of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.).

In some embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

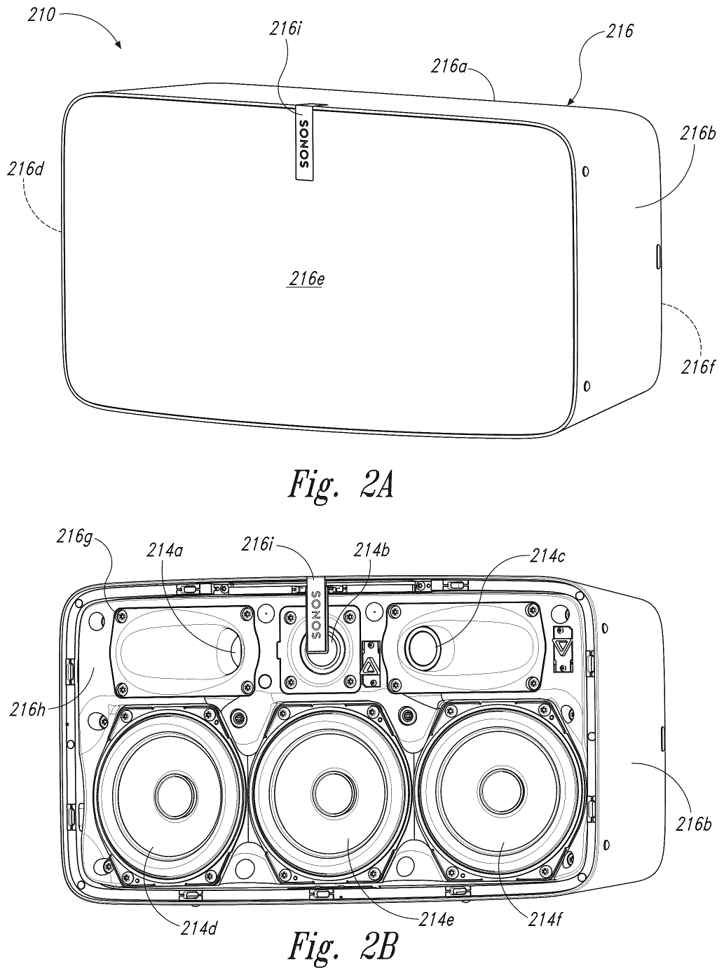

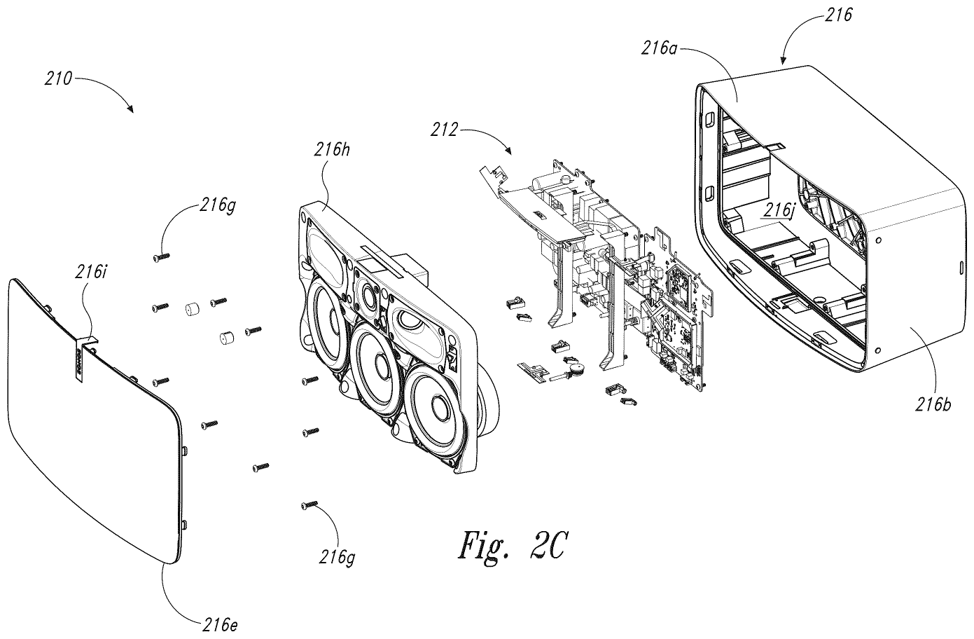

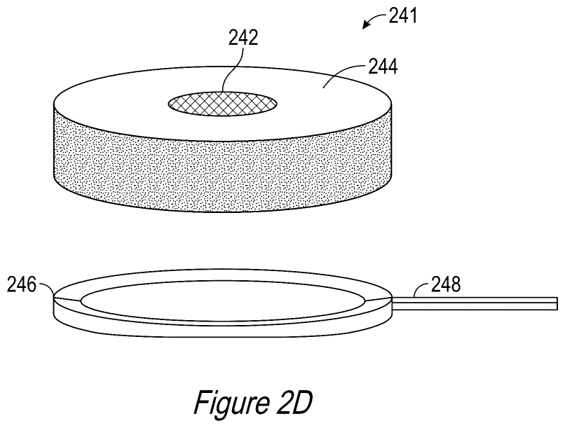

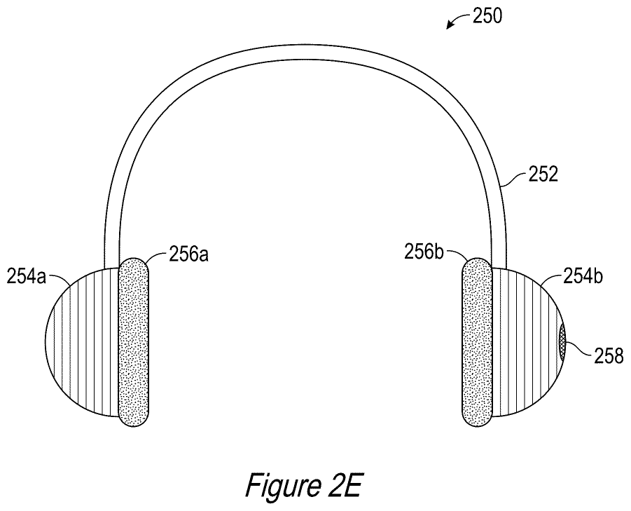

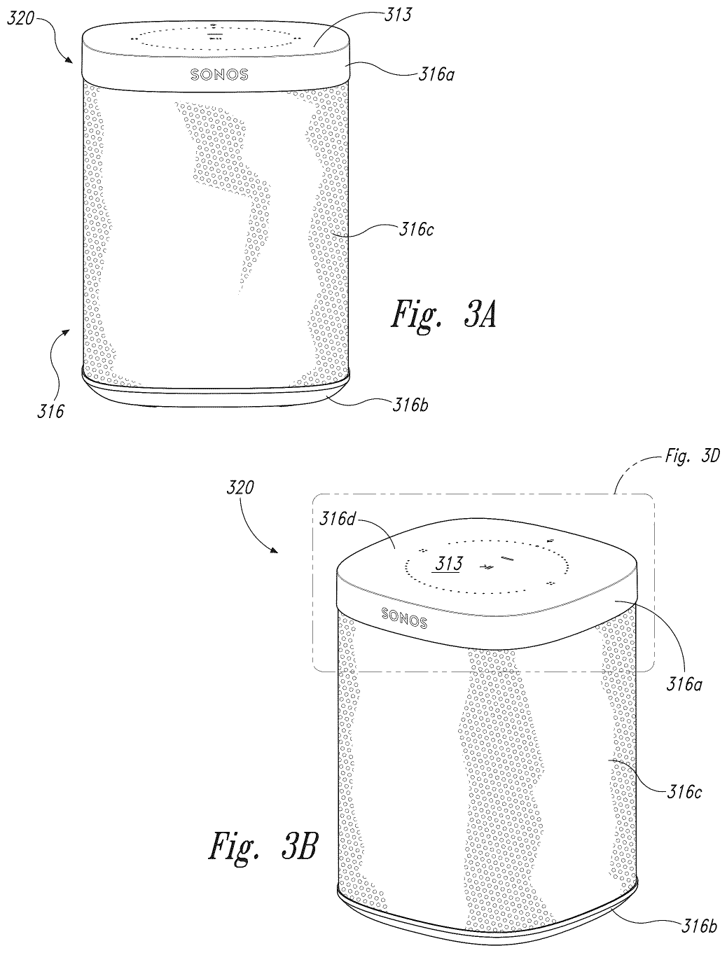

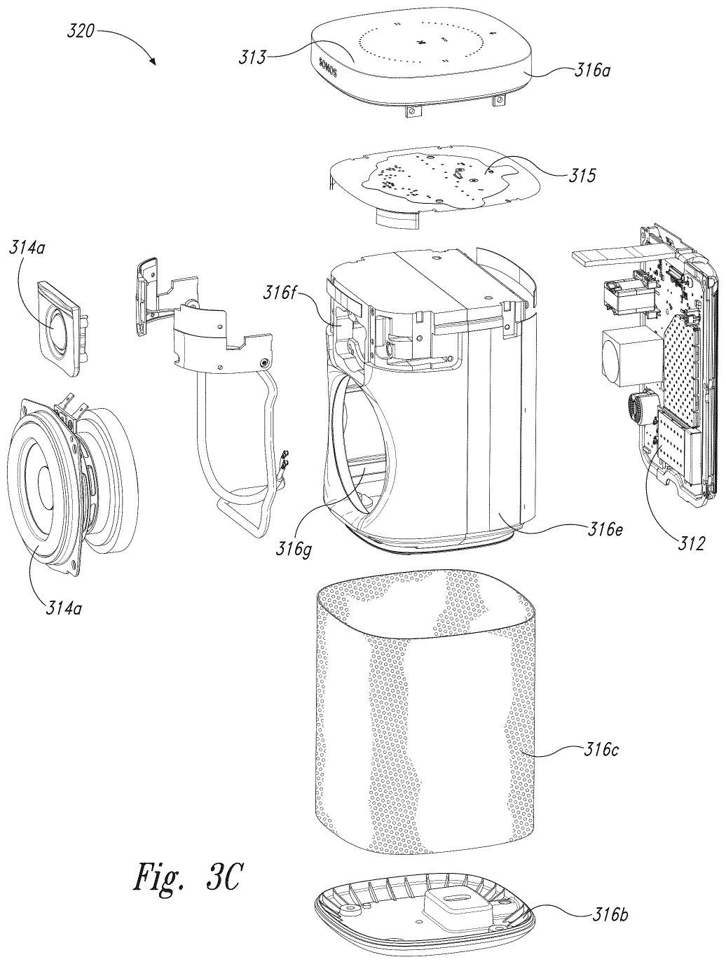

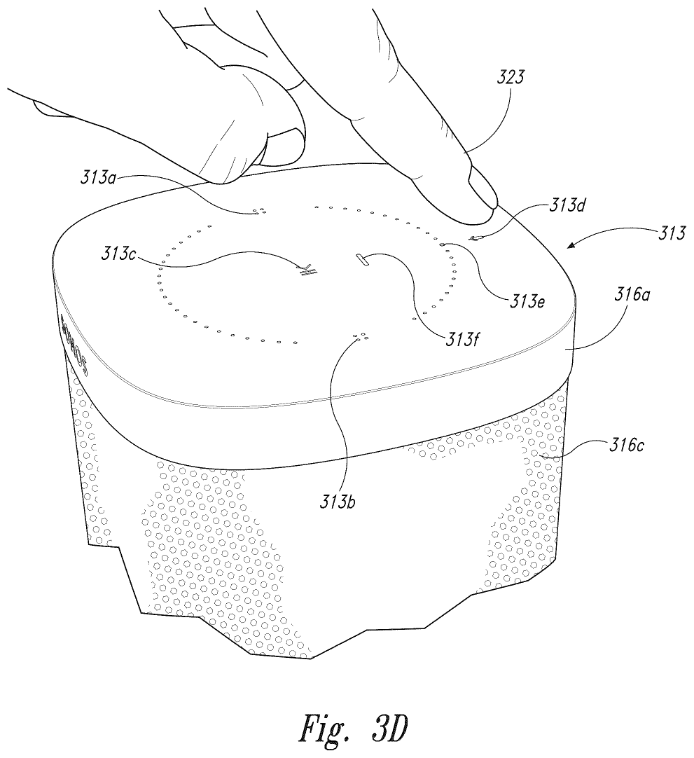

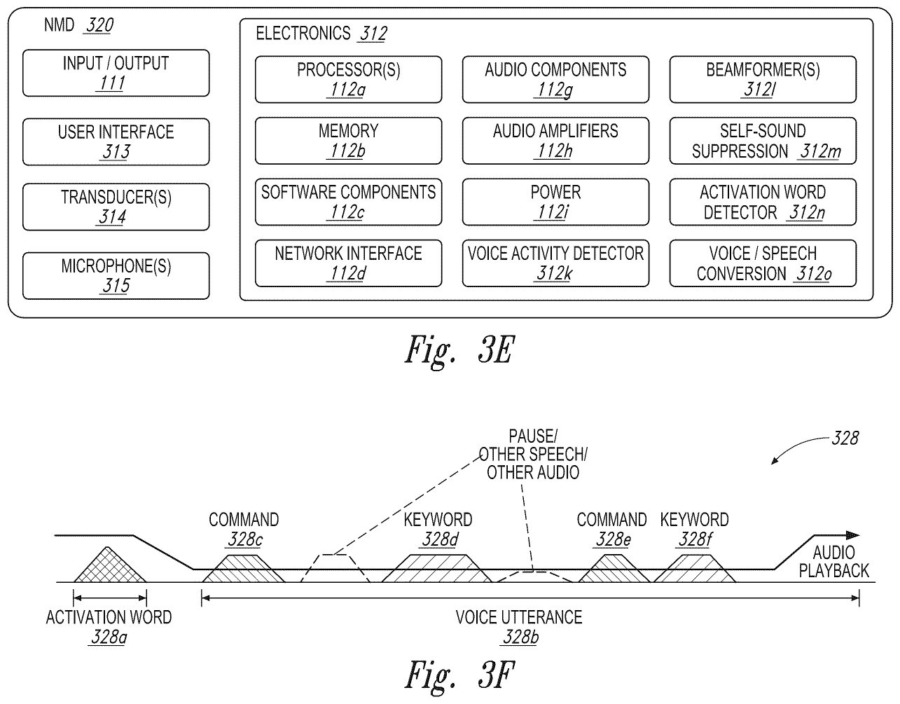

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, the power components 112i, and the microphones 115. As described elsewhere herein, the power components 112i can include one or more of: a wireless power transmitter (e.g., a laser, induction coils, etc.), a wireless power receiver (e.g., a photovoltaic cell, induction coils, etc.), an energy storage component (e.g., a capacitor, a rechargeable battery), an energy harvester, a wired power input port, and/or associated power circuitry. In operation, an NMD 120a can be configured to transmit wireless power to one or more external devices. Additionally or alternatively, the NMD 120a can be configured to receive wireless power from one or more external transmitter devices, in addition to or instead of receiving power over a wired connection.

The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™. an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11 g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of playback devices. The network interface 132d can also transmit and/or receive configuration changes such as, for example, adding/removing one or more playback devices to/from a zone, adding/removing one or more zones to/from a zone group, forming a bonded or consolidated player, separating one or more playback devices from a bonded or consolidated player, among others. Additional description of zones and groups can be found below with respect to FIGS. 1-I through 1M.

The user interface 133 is configured to receive user input and can facilitate ‘control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™. an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

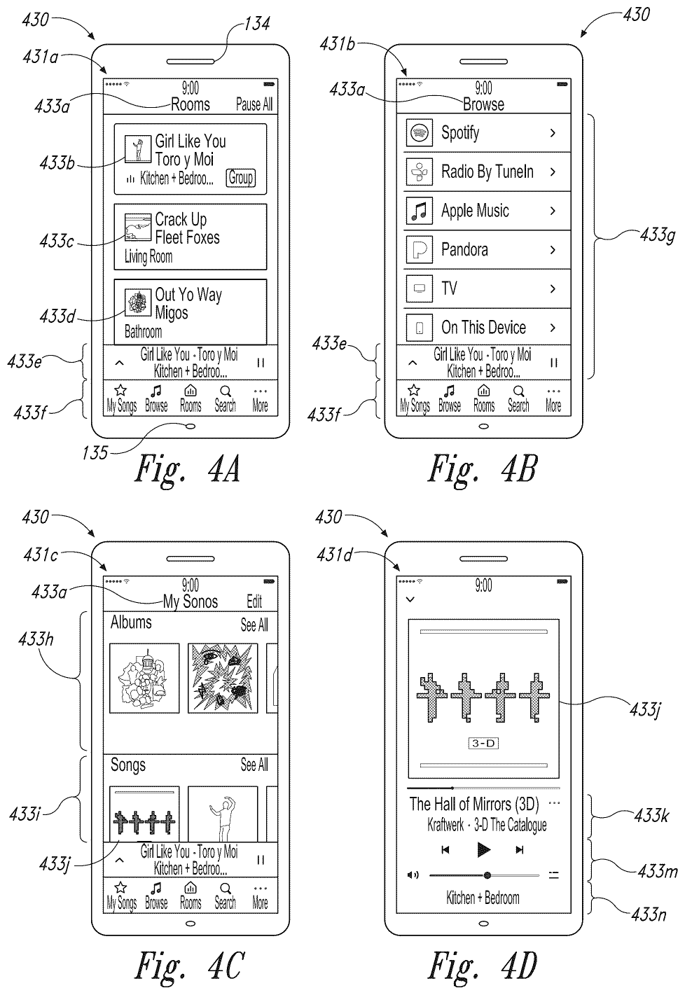

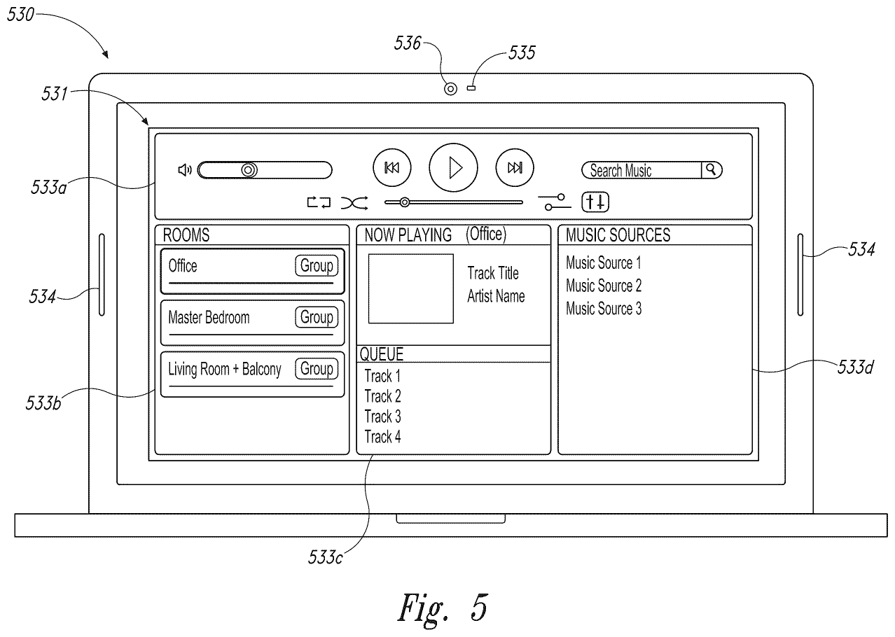

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones. Additional control device embodiments are described in further detail below with respect to FIGS. 4A-4D and 5.

c. Suitable Playback Device Configurations

FIGS. 1-I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110l (e.g., a left playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110g and 110h can be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1-I, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 11On the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “al” to identify playback device(s) of a zone, a second type “b1” to identify playback device(s) that may be bonded in the zone, and a third type “cl” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the media playback system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and Manipulating Groupings in a Multi-Zone Media System.” Each of these applications is incorporated herein by reference in its entirety. In some embodiments, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated embodiment of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some embodiments, however, the playback device 210 omits the filter 216i. In other embodiments, the playback device 210 includes one or more additional filters aligned with the transducers 214b and/or at least another of the transducers 214.

In some examples, the playback device 210 may be constructed as a portable playback device, such as an ultra-portable playback device, that comprises an internal power source. FIG. 2D shows an example housing 241 for such a portable playback device. As shown, the housing 241 of the portable playback device includes a user interface in the form of a control area 242 at a top portion 244 of the housing 241. The control area 242 may include a capacitive touch sensor for controlling audio playback, volume level, and other functions. The housing 241 of the portable playback device may be configured to engage with a dock 246 that is connected to an external power source via cable 248. The dock 246 may be configured to provide power to the portable playback device to recharge an internal battery. In some examples, the dock 246 may comprise a set of one or more conductive contacts (not shown) positioned on the top of the dock 246 that engage with conductive contacts on the bottom of the housing 241 (not shown). In other examples, the dock 246 may provide power from the cable 248 to the portable playback device without the use of conductive contacts. For example, the dock 246 may wirelessly charge the portable playback device via one or more inductive coils integrated into each of the dock 246 and the portable playback device.

In some examples, the playback device 210 may take the form of a wired and/or wireless headphone (e.g., an over-car headphone, an on-car headphone, or an in-car headphone). For instance, FIG. 2E shows an example housing 250 for such an implementation of the playback device 210. As shown, the housing 250 includes a headband 252 that couples a first earpiece 254a to a second earpiece 254b. Each of the earpieces 254a and 254b may house any portion of the electronic components in the playback device, such as one or more speakers, and one or more microphones. In some instances, the housing 250 can enclose or carry one or more microphones. Further, one or more of the earpieces 254a and 254b may include a control area 258 for controlling audio playback, volume level, and other functions. The control area 258 may comprise any combination of the following: a capacitive touch sensor, a button, a switch, and a dial. As shown in FIG. 2D, the housing 250 may further include car cushions 256a and 256b that are coupled to earpieces 254a and 254b, respectively. The car cushions 256a and 256b may provide a soft barrier between the head of a user and the earpieces 254a and 254b, respectively, to improve user comfort and/or provide acoustic isolation from the ambient (e.g., passive noise reduction (PNR)). In some implementations, the wired and/or wireless headphones may be ultra-portable playback devices that are powered by an internal energy source and weigh less than fifty ounces.

In some examples, the playback device 210 may take the form of an in-ear headphone device. It should be appreciated that the playback device 210 may take the form of other wearable devices separate and apart from a headphone. Wearable devices may include those devices configured to be worn about a portion of a subject (e.g., a head, a neck, a torso, an arm, a wrist, a finger, a leg, an ankle, etc.). For example, the playback device 210 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an car of the subject.

While specific implementations of playback and network microphone devices have been described herein, there are numerous configurations of devices, including, but not limited to, those having no UI, microphones in different locations, multiple microphone arrays positioned in different arrangements, and/or any other configuration as appropriate to the requirements of a given application. For example, UIs and/or microphone arrays can be implemented in other playback devices and/or computing devices rather than those described herein. Further, although a specific example of playback device 210 is described with reference to MPS 100, one skilled in the art will recognize that playback devices as described herein can be used in a variety of different environments, including (but not limited to) environments with more and/or fewer elements, without departing from this invention. Likewise, MPSs as described herein can be used with various different playback devices.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 315 are configured to received sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio information corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control). A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 3120 (e.g., voice-to-text and text-to-voice). In the illustrated embodiment of FIG. 3E, the foregoing components 312k-3120 are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise. The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first- and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g., AMAZON's ALEXA®, APPLE's SIRI®, or MICROSOFT's CORTANA®) can each use a different activation word for invoking their respective voice service. To support multiple services, the activation word detector 312n may run the received audio through the activation word detection algorithm for each supported voice service in parallel.

The speech/text conversion components 3120 may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include an activation word portion 328a and a voice utterance portion 328b. In some embodiments, the activation word 557a can be a known activation word, such as “Alexa,” which is associated with AMAZON's ALEXA®. In other embodiments, however, the voice input 328 may not include an activation word. In some embodiments, a network microphone device may output an audible and/or visible response upon detection of the activation word portion 328a. In addition or alternately, an NMB may output an audible and/or visible response after processing a voice input and/or a series of voice inputs.

The voice utterance portion 328b may include, for example, one or more spoken commands (identified individually as a first command 328c and a second command 328c) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 557a. The media playback system 100 may restore the volume after processing the voice input 328, as shown in FIG. 3F. Such a process can be referred to as ducking, examples of which are disclosed in U.S. Pat. No. 10,499,146, titled “Voice Control of a Media Playback System,” which is herein incorporated by reference in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433c includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selections a graphical representation 433j (FIG. 4C), the control device 430 can be configured to begin play back of audio content corresponding to the graphical representation 433j and output a fourth user interface display 431d fourth user interface display 431d includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533b, a playback zone region 533c, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some embodiments, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as a playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the playback queue. In some embodiments, audio items in a playback queue may be saved as a playlist. In certain embodiments, a playback queue may be empty, or populated but “not in use” when the playback zone or zone group is playing continuously streaming audio content, such as Internet radio that may continue to play until otherwise stopped, rather than discrete audio items that have playback durations. In some embodiments, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

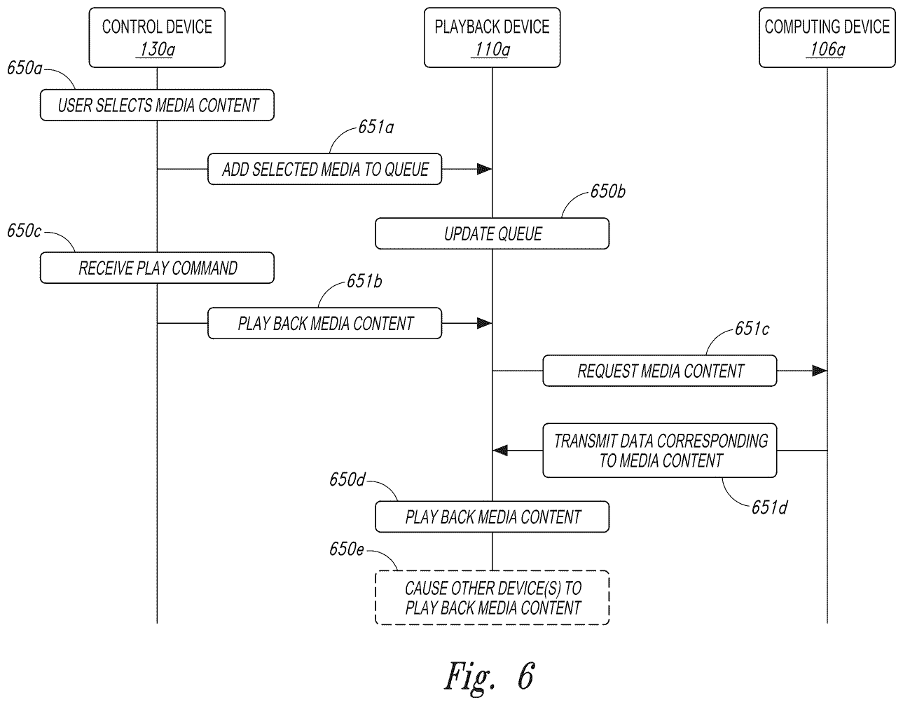

FIG. 6 is a message flow diagram illustrating data exchanges between devices of the media playback system 100 (FIGS. 1A-1M).

At step 650a, the media playback system 100 receives an indication of selected media content (e.g., one or more songs, albums, playlists, podcasts, videos, stations) via the control device 130a. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the first computing device 106a requesting the selected media content. The first computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the first computing device 106a, and begin playback of the selected media content in response to a message from the playback device 110a such that all of the devices in the group play back the selected media content in synchrony.

### IV. Wireless Power Transfer Devices and Associated Systems and Methods

Audio playback devices capable of receiving wireless power provide several distinct advantages over conventional wired devices. For example, there is no need to hide unsightly power cords by routing them through a wall or underneath furniture. Wireless power transfer may also allow a user to reposition devices more easily around a home or room without needing to disconnect or re-route power cords. To enable this functionality, one or more wireless power transmitter devices can be provided in the vicinity of an audio playback device having a wireless power receiver therein. Such a transmitter device can include another playback device (e.g., a soundbar, subwoofer, or any playback device having a wired power connection), or a non-playback device (e.g., a power hub that provides wireless power to the playback device without itself driving audio output). In some examples, one or more playback devices can include both a wireless power receiver and a wireless power transmitter, such that these devices may be used in either configuration, or in some instances may be used in both configurations simultaneously (e.g., as a “relay” in which a device receives wireless power from an external transmitter device and transmits wireless power to an external receiver device). In some instances, a plurality of such playback devices can transfer wireless power among one another in a mesh configuration, with the particular device-to-device transmission being selected to provide the desired power levels, device performance, and user experience.

As used herein, a “wireless power transmitter” or “transmitter device” includes any device (or component(s) of a device) capable of sending wireless power that can be received and recovered by a suitable receiver device. Similarly, a “wireless power receiver” or “receiver device” includes any device (or component(s) of a device) capable of receiving wireless power from a remote transmitter device and utilizing that power to operate one or more components of the receiver device (e.g., to power at least one amplifier of a playback device). In various examples, a single playback device (or other device) can be both a wireless power transmitter and a wireless power receiver, while in other examples a particular device may be only a transmitter device or only a receiver device.

In various examples disclosed herein, such wireless power transfer can include mid- or long-range wireless power transfer. As used herein, mid- and long-range wireless power transfer includes wireless power transfer over a distance of greater than about 10 cm, or in some examples greater than about 50 cm or greater than about 1 m. For example, in some instances a wireless power transmitter device and a wireless power receiver device can be separated from one another by at least about 10 cm, at least about 50 cm, or at least about 1 m during wireless power transfer.

As noted elsewhere herein, such mid- or long-range wireless power transfer technologies include radiative techniques (e.g., lasers, radio waves, microwaves, or other such propagation of electromagnetic radiation from the transmitter device towards the receiver device). In various examples, the wireless power receiver in such instances can include a photovoltaic cell, a diode, an antenna (e.g., a rectenna), or other suitable hardware that can convert electromagnetic radiation into electrical energy. Similarly, the wireless power transmitter in such instances can include an optical source such as a laser, a microwave source, an antenna (e.g., directional antennas, phased array antennas, etc.), or other suitable source of electromagnetic radiation.

Additionally or alternatively, such mid- or long-range wireless power transmission can include non-radiative transmission such as electromagnetic coupling (e.g., inductive coupling, resonant inductive coupling, capacitive coupling, resonant capacitive coupling, magnetodynamic coupling, etc.). In such instances, both the wireless power transmitter and the wireless power receiver can include electrically conductive coils (e.g., in the case of inductive coupling), electrodes (e.g., in the case of capacitive coupling), or rotating armatures carrying magnets thereon (e.g., in the case of magnetodynamic coupling).

a. Suitable Wireless Power Transfer Device Components

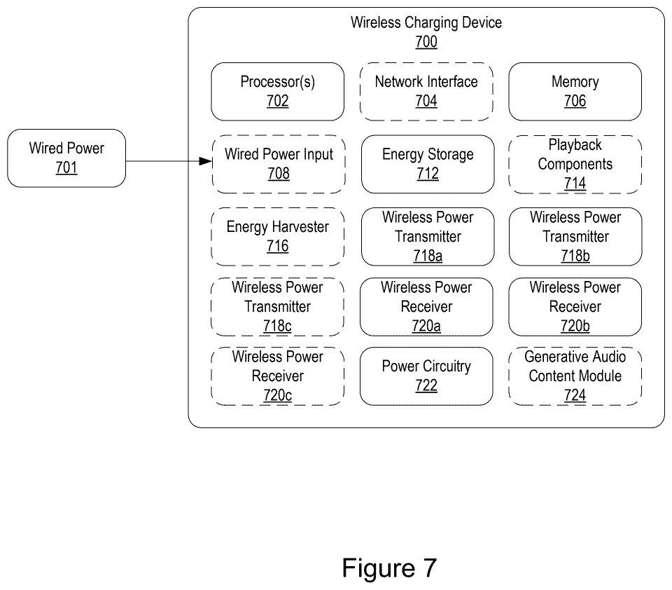

FIG. 7 is a schematic block diagram of a wireless charging device 700 in accordance with examples of the present technology. In some examples, the device 700 can be coupled to, integrated into, or included within a playback device (e.g., playback device 110a of FIG. 1C), an NMD (e.g., NMD 120a of FIG. 1F), or other suitable device.

Referring to FIG. 7, the wireless charging device 700 includes one or more processors 702, a network interface 704, and memory 706. These can be similar to, identical to, or include, processors 112a, network interface 112d, and memory 112b described above with respect to Figures IC and IF. In various examples, the wireless power transfer device 700 can include any or all of the features of playback device 110a or NMD 120a described previously herein. In some examples, the network interface 704 can include one or more transceivers that are configured to communicate via at least one WIFI network, and/or at least one BLUETOOTH network.

Wireless charging device 700 optionally includes a wired power input port 708 that is configured to be electrically coupled to wired power 701 (e.g., via 110/220V wall power, a USB-C charger, etc.), such as an AC power port or a USB port (e.g., a USB TYPE-A port, a USB TYPE-B port, a USB TYPE-C port, etc.). The power input port 708 can be coupled (e.g., via cable) directly to a household power outlet (e.g., to receive alternating current (AC) power) or indirectly via a power adapter (e.g., a device that converts the AC power from the household power outlet to direct current (DC) power). In some examples, the wired power input port 708 is omitted, and the wireless charging device 700 operates solely on the basis of power received wirelessly from external transmitter device(s) and/or energy generated via energy harvester(s) 716.

The wireless charging device 700 further includes an energy storage component 712, which can take the form of a rechargeable battery, a capacitor, a supercapacitor, or any other suitable component that can store energy. The energy storage component 712 can be configured to store energy and to facilitate operation of the device (e.g., powering one or more amplifiers of a playback device). In this regard, the energy storage component 712 can be a battery that has a chemistry that facilitates recharging the battery, such as lithium-ion (Li-ion), nickel-metal hydride (NiMH), etc. The battery can be sized such that the processor(s) 702 and other components of the wireless charging device 700 can operate on battery power alone for an extended amount of time without the battery needing to be recharged. For example, the battery can have a 20 watt-hours (Wh) capacity that facilitates continuous playback of audio for at least 4 hours on battery power alone. The battery can be charged using power from one or more other components in the device 700 (e.g., wired power input port 708, wireless power receiver(s) 720, energy harvester 716, etc.).

As noted previously, in some examples, the wireless power device 700 can include audio playback components 714 (e.g., one or more transducers, audio processing circuitry, microphones, voice processing circuitry, etc.), and as such the wireless charging device 700 can include or be part of an audio playback device or a network microphone device as described elsewhere herein. In various examples, such an audio playback device can be a soundbar, a subwoofer, a headphone device, a hearable device, an extended reality (e.g., virtual reality, mixed reality, augmented reality) device, a portable audio playback device, an architectural playback device, or a video playback device (e.g., a projector or television).

The wireless charging device 700 optionally includes one or more energy harvesters 716. Energy harvesters 716 may include those devices configured to derive power from energy sources in the environment (e.g., solar energy, thermal energy, wind energy, salinity gradients, kinetic energy, sound energy, etc.). For example, the energy harvesters 716 can include one or more photovoltaic cells configured to convert received light into a voltage. Any of a variety of energy harvesters 716 may be included in the wireless charging device 700. Examples of such energy harvesters include photovoltaic cells, thermoelectric generators, micro wind turbines, piezoelectric crystals, electroacoustic transducers, and kinetic energy harvesters.

The wireless charging device additionally includes two or more wireless power transmitters 718a-c, a wireless power receiver(s) 720, and power circuitry 722. In operation, the wireless charging device 700 can receive wireless power from an external transmitter device via the receiver(s) 720, and can transmit wireless power to an external receiver device via the transmitters 718, with the power circuitry 722 controlling some or all of the functions associated with these operations.

The two or more wireless power transmitters 718a-c can include any component or combination of components capable of transmitting wireless power to an external wireless power receiver device. Such wireless power transfer can include short-, mid-, or long-range wireless power transfer, for example being configured to provide effective power transfer with the transmitter and receiver separated from one another by a distance of greater than about 10 cm, or in some examples greater than about 50 cm or greater than about 1 m. In various examples, at least one of the wireless power transmitters 718 can transmit power via radiative techniques such as using lasers, radio waves, microwaves, or other such techniques involving propagation of electromagnetic radiation from the transmitter device towards the receiver device. In various embodiments, such electromagnetic radiation may be directional (e.g., directed towards one or more receiver devices) or omnidirectional (e.g., radiating in substantially all directions from a wireless power transmitters 718). In various examples, at least one of the wireless power transmitters 718 in such instances can include an optical source such as a laser, a microwave source, an antenna (e.g., directional antennas, phased array antennas, etc.), or any other source of electromagnetic radiation. In some instances, the wireless power transmitters 718 can include one or more steering components configured to direct, focus, or steer wireless power. Such steering components can include, for example, one or more lenses, mirrors, directional antennas, or other suitable components.

Additionally or alternatively, the wireless power transmitters 718 include a power transmitter configured to transmit wireless power using non-radiative techniques such as electromagnetic coupling (e.g., inductive coupling, resonant inductive coupling, capacitive coupling, resonant capacitive coupling, magnetodynamic coupling, etc.). In such instances, the wireless power transmitter 718 can include electrically conductive coils (e.g., in the case of inductive coupling), electrodes (e.g., in the case of capacitive coupling), rotating armatures carrying magnets thereon (e.g., in the case of magnetodynamic coupling), or any other suitable structure capable of receiving power wirelessly via electromagnetic coupling.

The wireless power receiver(s) 720 can include any component or structure configured to receive power wirelessly (e.g., via inductance, resonance, radiation, etc.) from an external wireless transmitter device. As noted previously, such wireless power transfer can include mid- or long-range wireless power transfer, for example being configured to provide effective power transfer with the transmitter and receiver separated from one another by a distance of greater than about 10 cm, or in some examples greater than about 50 cm or greater than about 1 m. In various examples, the wireless power receiver(s) 720 can receive power via radiative techniques such as lasers, radio waves, microwaves, or other such techniques involving propagation of electromagnetic radiation from the transmitter device towards the receiver device. The wireless power receiver(s) 720 in such instances can include an optical receiver such as a diode, a photovoltaic cell, an antenna (e.g., a rectenna), or other suitable hardware that can convert electromagnetic radiation into electrical energy.

Additionally or alternatively, the wireless power receiver(s) 720 can be configured to receive wireless power using non-radiative techniques such as electromagnetic coupling (e.g., inductive coupling, resonant inductive coupling, capacitive coupling, resonant capacitive coupling, magnetodynamic coupling, etc.). In such instances, the wireless power receiver(s) 720 can include electrically conductive coils (e.g., in the case of inductive coupling), electrodes (e.g., in the case of capacitive coupling), a rotating armature carrying a magnets thereon (e.g., in the case of magnetodynamic coupling), or any other suitable structure capable of receiving power wirelessly via electromagnetic coupling.

With continued reference to FIG. 7, the wireless charging device 700 can include power circuitry 722 configured to receive power from the energy storage component 712, the wired power input port 708, and/or the wireless power receiver(s) 720, and, using the power obtained therefrom, drive an amplifier and/or an electroacoustic transducer with an audio output based on source audio. The power circuitry 722 can be configured to perform any of a variety of power-related tasks including, for example, one or more of the following: (1) power conversion (e.g., AC-AC conversion, AC-DC conversion, DC-AC conversion, and/or DC-DC conversion); (2) power regulation; (3) battery charging; and/or (4) power monitoring (e.g., battery monitoring). Examples of electrical components that may be integrated into the power circuitry 722 include transformers, rectifiers, inverters, converters, regulators, battery chargers, and/or power management integrated circuits (PMICs). In some examples, such power circuitry 722 can be integrated into either or both the wireless power transmitter 718 and the wireless power receiver(s) 720.

In some examples, the power circuitry 722 can include battery circuitry that facilitates monitoring a state of a battery. In these examples, the battery circuitry can identify battery state information that includes information regarding one or more of the following battery states: a state-of-charge (SoC), temperature, age, and/or internal impedance. The battery circuitry can communicate the battery state information to, for example, the processor 702.

The power circuitry 722 can include regulation circuitry that facilitates converting a variable amount of voltage (e.g., a variable voltage from a battery, a variable voltage from an energy harvester, etc.) to a stable DC voltage. For example, the regulation circuitry can include switching regulator circuitry such as buck, boost, buck-boost, flyback, resonant, etc. switching regulator circuitry. The regulation circuitry can include one or more linear voltage regulators such as low-dropout (LDO) regulators. The regulation circuitry can be configured to output one or more fixed DC voltages (e.g., +5V, +12V) or AC voltages.

The wireless charging device 700 can also optionally include an artificial intelligence (AI) component(s) such as a generative media module 724 that is configured to produce generative media content, either alone or in conjunction with other devices (e.g., other local playback and non-playback devices, remote computing, etc.) Generative media content can include any media content (e.g., audio, video, audio-visual output, tactile output, text, or any other media content) that is dynamically created, synthesized, and/or modified by a non-human, rule-based process such as an algorithm or model(s) (e.g., one or more neural networks, transformer models, large language models), even if human input is involved in the process. Although such processes can be rule-based, they need not be wholly deterministic, but may instead incorporate some aspect of randomness or other stochastic behavior. This creation or modification can occur for playback in real-time or near real-time. Additionally or alternatively, generative media content can be produced or modified asynchronously (e.g., ahead of time before playback is requested), and the particular item of generative media content may then be selected for playback at a later time. As used herein, a “generative media module” includes any system, whether implemented in software, a physical model, or combination thereof, that can produce generative media content based on one or more inputs. In some examples, such generative media content includes novel media content that can be created as wholly new or can be created by mixing, combining, manipulating, or otherwise modifying one or more pre-existing pieces of media content. As used herein, a “generative media content model” includes any algorithm, schema, set of rules, neural network (e.g., transformer model) that can be used to produce novel generative media content using one or more inputs (e.g., sensor data, audio captured by on-board microphones, artist-provided parameters, media segments such as audio clips or samples, etc.). Among examples, a generative media module can use a variety of different generative media content models to produce different generative media content. In some instances, artists or other collaborators can interact with, author, and/or update generative media content models to produce particular generative media content. Although several examples throughout this discussion refer to audio content, the principles disclosed herein can be applied in some examples to other types of media content, e.g., video, audio-visual, tactile, or otherwise.

In some examples, the generative media module 724 (or another suitable AI component) can utilize one or more input parameters, such as data from sensors, in the form of playback device capabilities (e.g., number and type of transducers, output power, other system architecture), or device location (e.g., either location relative to other playback devices, relative to one or more users). Additional inputs can include a device state of one or more devices within the group, such as a thermal state (e.g., if a particular device is in danger of overheating, the generative content can be modified to reduce temperature), battery level (e.g., bass output can be reduced in a portable playback device with low battery levels), and bonding state (e.g., whether a particular playback device is configured as part of a stereo pair, bonded with a sub, or as part of a home theatre arrangement, etc.). In some examples, the generative media module 724 selects a charging modality based on one or more inputs, such as any of those described above. Any other suitable device characteristic or state may similarly be used as an input for production of generative media content.

In the case of a wearable playback device, the position and/or orientation of the playback device relative to the environment can serve as an input for the generative media module 724. For instance, a spatial soundscape can be provided such that, when a user moves about an environment, the corresponding audio produced changes (e.g., waterfall sounds in one corner of a room, birdsong in another). Additionally or alternatively, as the user's orientation changes (facing one direction, tilting her head upward or downward, etc.), the corresponding audio output can be modified accordingly.

A user identity can also serve as an input to the generative media module 724, such that the particular generative media produced by the generative media module 724 is tailored to the individual user. Another example input parameter includes user presence—for example when a new user enters a space playing back audio (e.g., pre-existing audio, generative audio, or a combination thereof) the user's presence can be detected (e.g., via proximity sensors, a beacon, etc.) and the generative audio can be modified as a response. This modification can be based on a number of users (e.g., with ambient, meditative audio for 1 user, relaxing music for 2-4 users, and party or dance music for greater than 4 users present). The modification can also be based on the identity of the user(s) present (e.g., a user profile based on the user's characteristics, listening history, or other such indicia).

Additional details regarding production and playback of generative media content can be found in commonly owned International Patent Application Publication Nos. WO2022/109556, titled “Playback of Generative Media Content” and WO2024/073297, titled “Generative Audio Playback via Wearable Playback Devices,” each of which is hereby incorporated by reference in its entirety.

b. Compatible Device for Charging via Multiple Power Transmission Modalities

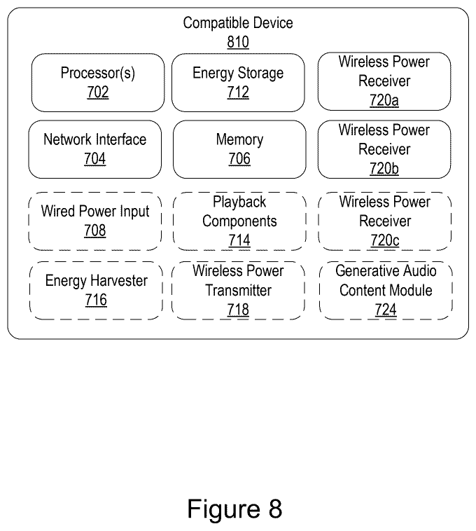

FIG. 8 shows a device configured to be charged via multiple power transmission modalities in accordance with examples of the present technology. In the example shown in FIG. 8, compatible device 810 includes multiple wireless power receivers, each capable of receiving power transmitted via one or more power transmission modalities. The compatible device can include some or all (not shown) of the components described above with respect to the wireless charging device 700 of FIG. 7. In some examples, some or all of these devices can include or be audio playback devices (e.g., devices equipped with one or more audio transducers, audio source components such as a turntable, an amplifier or receiver device) and/or video playback devices (e.g., projectors, televisions).

As used herein, a “power group” can include two or more devices that are configured to wirelessly transfer power therebetween. For example, a charging device can transmit wireless power (e.g., via a wireless power transmitter) to each of one or more compatible devices (e.g., simultaneously). Additionally, a playback device may transmit wireless power to power group member. In some examples, a device may transmit wireless power to fewer than all members of the wireless power group, with one or more group members transmitting power to other group members such that each device of the group receives or transmits wireless power to or from at least one other device of the group.

In some cases, a wireless charging device may not include wireless power receiver(s) 720 and may be connected to wired power 701. However, in other instances the wireless charging device may have no connection to wired power 701, and may itself only be powered via wireless power transmission and/or energy harvesting. In some examples, one or more of the power group members may be connected to wired power instead of or in addition to receiving wireless power from other group members.

As used herein, a “power group coordinator” can include a wireless power transfer device that is configured to transmit instructions to one or more power group members to initiate, cease, or modulate wireless power transmission therebetween according to a preferred modality. For example, a power group coordinator may cause a first power group member to initiate wireless power transmission to a second power group member. As described in more detail elsewhere herein, in some examples wireless power transmission may be initiated, ceased, or modified based on a number of parameters (e.g., a battery level of a device, a level or rate or wireless power received at a device, audio playback levels, etc.). In some examples, such parameters may be determined by or transmitted to the power group coordinator, which may then determine any appropriate modifications to wireless power transfer within the group, and may transmit instructions to group members accordingly.

As noted previously, in some examples a plurality of audio playback devices can be grouped together for synchronous audio playback (e.g., as a bonded zone). In such instances, one of the playback devices may be a coordinator of the group, and may transmit and receive timing information from one or more other devices in the group. In various examples, the power group may be identical to the audio playback group. Alternatively, the power group may differ at least in part from any audio playback grouping. In at least some examples, the power group coordinator may also serve as an audio playback group coordinator. In such cases, the power group coordinator may transmit timing data or other information to group members via a wireless network and/or via data incorporated into the wireless power signals, as described in more detail elsewhere herein. Alternatively, the power group coordinator and the audio playback group coordinator may be different devices. In still other examples, the power group may be formed without any audio playback grouping taking place, in which case there may be no audio playback group coordinator.

c. Energy Harvester Devices

Playback devices, wireless charging devices, or other suitable devices can include energy harvesting components. Such devices are referred to herein as “energy harvester devices,” which can include any device that is configured to obtain or derive ambient energy from the environment rather than or in addition to obtaining electrical power from the power grid, a battery, or another electronic device. Such energy harvester devices can take the form of dedicated energy harvester devices (e.g., a special purpose device for obtaining and distributing power from environmental sources), audio playback devices equipped with energy harvesting capabilities, architectural features (e.g., windows, blinds, shades, curtains, planters, lights, etc.) equipped with energy harvesting capabilities, or any other suitable type of device or form factor.

An energy harvester device can be placed in a position beneficial for energy harvesting, and may then transmit power to external receiver devices within the environment. For example, a playback device equipped with solar panels and a large energy storage device (e.g., one or more batteries) can be placed near a window indoors or perhaps outside unobstructed. The energy harvester device can be configured to wirelessly transmit energy to one or more external playback devices within the environment. As such, the energy captured via the energy harvester device is distributed to adjacent playback devices, which may provide some or all of the power needed for each device to run while in an idle state. As used herein, an “energy harvester device” can include any device with energy harvesting components that is configured to obtain or derive energy from the environment rather than from the power grid. Such devices can take the form of dedicated energy harvester devices or audio playback devices equipped with energy harvesting capabilities.

Energy harvesting is the process of collecting and converting ambient energy sources, such as solar energy, thermal energy, wind energy, kinetic energy, or others, into electrical energy that can be used by small electronic devices (e.g., wireless devices). Energy harvester devices can provide a sustainable and low-cost alternative to the use of grid power or large batteries for powering various applications. In various examples, energy harvester devices can be configured to harvest solar energy, thermal energy, wind energy, salinity gradients, kinetic energy, sound energy, or any other suitable ambient energy from the environment. Examples of such energy harvesters include photovoltaic cells, thermoelectric generators, micro wind turbines, piezoelectric crystals, electroacoustic transducers, and kinetic energy harvesters.

By incorporating one or more energy harvester devices into a media playback system, for example, the overall use of grid electrical power can be reduced. In some instances, the use of stored battery power may also be reduced, thereby extending the life of existing batteries and lowering the overall demands of battery sizes for a given level of device performance.

In some implementations, an energy harvester device can transmit power to other devices within the environment (e.g., other devices within a media playback system, within the user's home or office, etc.). Such power transmission can take the form of wireless power transmission or wired power transmission via a physical wired connection between devices. Wireless power transmission may be particularly beneficial, as it eliminates the need for wires or cables that may be inconvenient, unattractive, or hazardous. In various examples, wireless power transmission can be achieved by using electromagnetic induction, electromagnetic radiation, or any other suitable method for wirelessly transmitting power between devices.

In the case of media playback systems including one or more playback devices, the use of energy harvester devices can improve the efficiency of the system, reducing the overall demand for electrical grid power, extending battery life, and/or reducing the requirements for battery capacity. In a typical media playback system, playback devices are in an idle state for the majority of the day (e.g., 85% or about 20 hours per day). In this idle state, the playback devices play back no media content, but may nonetheless consume a non-negligible amount of electrical energy to perform background tasks, such as capturing and processing microphone sound data for voice assistant service activation words and communicating state information to other devices in the media playback system.

In some examples, each of the playback devices can be limited to the use of grid power (i.e., power received via a power cord or plug-in charger) while that playback device is in an active state. During periods in which the playback device is in an idle state, the playback device may instead rely on harvested energy (e.g., energy derived from its own energy harvesting components (e.g., an integrated solar panel) or energy derived from a discrete energy harvester device which is then transmitted (via wired or wireless connection) to the playback device. For instance, relatively compact solar panels with sufficient exposure to the sun may generate enough energy (e.g., 2 watts (W) or less) to continuously power an idle playback device. However, playback devices are often positioned within environments at locations that are not ideal for energy harvesting (e.g., at a location far away from windows or other light sources in the case of solar panels). Instead, users typically position playback devices around the environment based on performance in audio playback, user convenience, aesthetic preferences, or other considerations. Accordingly, a given playback device equipped with energy harvesting components may only be able to reliably obtain a fraction of the requisite power for idle state operation based on harvesting ambient energy from the environment.

To accommodate playback devices that may be placed at non-ideal positions for energy harvesting, it can be beneficial to position one or more energy harvester devices at locations that are particularly suited to extracting ambient energy from the environment (e.g., a position near a sunny window in the case of solar panels, a position outside in the case of wind-based energy harvesters, etc.). The energy harvester device can also be configured to deliver energy to one or more external playback devices (or other electronic devices) within the environment. As noted previously, such transmission can be wireless or via a wired connection. This can enable a user to position the receiver devices at desired locations around the environment even if those locations are non-ideal for harvesting energy. Accordingly, one or more energy harvester devices can capture ambient energy from the environment and distribute energy to other playback devices within the environment for use as needed. This way, the energy harvester device can provide a continuous and convenient power supply for other devices without requiring physical contact or alignment.

In some implementations, the media playback system (or some component thereof) can modify operation of one or more devices depending on the amount of energy harvested via the energy harvester device, the amount of energy consumed via one or more devices, the current, scheduled, or predicted states of the various devices (e.g., active or idle), or various other factors.

Additional details regarding energy harvesting and power management can be found in commonly owned International Patent Application Publication No. WO2024/020580, titled “Power Management for Audio Playback Devices” and International Patent Application Publication No. WO2022/047503, titled “Wireless Power Transfer for Audio Playback Devices,” each of which is hereby incorporated by reference in its entirety.

### V. Example Wireless Charging Device Capable of Operating in Multiple Modalities

In some examples, the charging device comprises multiple power transmitters, each power transmitter capable of transmitting power to devices via a particular power transmission mode or modality. For example, the charging device can include a short-range power transmitter (e.g., an in-contact power transmitter), a mid-range power transmitter (e.g., a near-field power transmitter), a long-range power transmitter (e.g., an optical electromagnetic transmitter or a radio frequency transmitter), and so on. Depending on the relationship between the charging device and a portable device, the charging device can determine which modality to use to transmit power to the portable device. For example, if the wireless charging device is transmitting power to an implantable or a wearable device, such as a pair of headphones, via near-field power transmitter (e.g., a QI transmitter) and the charging device detects that the pair of headphones is no longer within the charging range threshold, the charging device can switch to another transmitter to transmit power to the pair of headphones over the longer distance and disable the near-field power transmitter. Thus, if a user wants to use the pair of headphones to listen to content, the charging device can continue transmitting power to the pair of headphones even though the pair of headphones are no longer in range of the near-field power transmitter. In some cases, the wireless charging device may be capable of detecting nearby compatible devices by, for example, periodically transmitting a test signal to determine whether any compatible devices are present (or not present). Conversely, if the wireless charging device is transmitting power to the pair of headphones via an RF transmitter and the charging device detects that the pair of headphones has come within range of its near-field power transmitter (e.g., if the user is done using the headphones and has placed the pair of headphones near a near-field charging device), the charging device can switch to the near-field power transmitter to provide power to the pair of headphones and disable the RF transmitter (e.g., if it is not being used to charge other devices). Similarly, the appropriate wireless power receivers can be enabled and disabled based on the selected power transmission modality. In this manner, the charging device has multiple options for transmitting power to portable devices and can select from these options to increase efficiency in charging and decrease power loss while providing more comprehensive coverage for charging portable devices.

In some examples, multiple charging devices, such as single-mode charging devices, are part of a coordinated charging system capable of transmitting power to compatible devices using different power transmission modalities. The charging devices may communicate with each other to coordinate charging of compatible devices. For example, a first charging device with at least a near-field power transmitter may be transmitting power to a compatible device, such as a playback device, via the near-field power transmitter. In the event that the first charging device detects that the playback device is no longer in range, the first charging device can notify a second charging device, such a charging device with at least a far-field power transmitter, that the first charging device is no longer transmitting power to the playback device. After receiving the notification, the second charging device can, if necessary, enable its power transmitter and attempt to transmit power to the playback device. Similarly, if the first charging device detects that the playback device is within its charging range, the first charging device can notify other charging devices so that the other power transmission devices can adjust by, for example, reducing or eliminating power transmission to the playback device. In some cases, the playback device may communicate these changes to the charging devices if, for example, one or more of the charging devices are not in communication with other charging devices. In this manner, the coordinated charging system has multiple options for transmitting power to portable devices and can select from these options to increase efficiency in charging and decrease power loss while providing more comprehensive coverage for charging portable devices.

As another example, if the wireless power transmitter is not transmitting power to a compatible device and the compatible device comes within an effective range of one or more of the power transmission modalities supported by the wireless power transmitter, the wireless charging device and compatible device can be configured to transmit and receive, respectively, power via one or more of the power transmission modalities and associated power transmitter(s). Although a wireless charging device with two transmitters is described in the example above, one of ordinary skill in the art will recognize that a charging device may include additional power transmitters to be used depending on the circumstances, such as the number and types of devices being charged, the extent to which the devices are using energy, past use information, and so on.

Accordingly, the disclosed charging device enables the portable devices to be used for longer periods without needing to be placed on or near a charging device. Moreover, because the wireless charging device can provide power via different power transmission modalities and transmitters, the portable device is less likely to run out of energy, thereby allowing one or more users to use the portable device for longer periods without interruption, thereby increasing overall use of the portable device.

The wireless charging device may be configured to detect the presence (or lack thereof) of a compatible device via any number of techniques. In some examples, the wireless charging device can determine or estimate the distance between the charging device and a compatible device by measuring a signal strength between the wireless charging device and the compatible device. In some cases, the compatible device may be configured to notify the wireless device of the rate at which its battery is being charged. In this manner, the wireless charging device can detect when one or more power transmission modalities are inefficient to charge the compatible device. In the event that the efficiency of each modality is below a threshold (e.g., 0.1 A, 0.5 A, 1 A), the wireless charging device may stop attempting to charge the compatible device until the compatible device is closer to the wireless charging device or otherwise able to be charged more efficiently. As another example, the wireless charging device and/or compatible device may detect the presence of each other by determining a time-of-flight measurement between the compatible device and the wireless charging device, such as the amount of time it takes for a signal or packet sent from one device to other and, in some cases, the amount of time it takes for the signal or packet to be return. As another example, the wireless charging device may analyze acoustic or ultrawideband (“UWB”) localization signals transmitted from a compatible device to assess the distance between the wireless charging device and the compatible device. Additional details regarding localization of devices using UWB or acoustic signals can be found, for example, in U.S. Pat. No. 11,809,782 entitled, “Audio Parameter Adjustment Based on Playback Device Separation Distance,” which is incorporated herein by reference in its entirety.

The wireless charging device may be configured to detect the presence (or lack thereof) of humans or other living beings within the vicinity of the wireless charging device. In the event that the presence of one or more living beings is detected, the wireless charging device may disable or restrict long range power transmission while allowing or modifying mid- and short-range power transmission. For example, the wireless charging device may limit the amount or rate of long- or mid-range power transmission, the direction of long- or mid-range power transmission, the number of devices that can be charged via long- or mid-range power transmission, and so on. When the living beings are no longer detected, the wireless charging device can lift any restrictions that may have been put in place. In this manner, the wireless charging device can cater to the safety needs or concerns of those nearby. In some examples, a user may be able to assign one or more restrictions to one or more power transmission modalities to be used when humans or other living beings are present.

As another example, the wireless charging device may analyze GPS or other location coordinates of the wireless charging device and a compatible device to assess the distance between the devices. One of ordinary skill in the art will recognize that a compatible device may be configured to detect the presence and location of a wireless charging device using any one or more of the above mentioned techniques.

In some examples, when a wireless charging device is triggered to transition from transmitting power to a compatible device via one power transmitter to another, the wireless charging device and/or the compatible device may be configured to perform additional actions. For example, if the wireless charging device is a component of a playback device or system that is currently receiving and playing back content (e.g., a sound bar, speaker, or other devices having one or more audio transducers) and a pair of headphones being charged by a near-field power transmitter of the playback device is removed (i.e., no longer within the near-field charging range), the playback device can transfer playback from the playback device to the headphones. In this manner, the user need not activate and connect the headphones to a source for playback. Rather, the user can simply pick up the headphones and continue their listening experience without interruption. This transition may occur via a network interface so that the headphones receive the music via a remote content source. Alternatively, the playback device may broadcast the content directly to the headphones. In some cases, rather than transferring playback completely to the headphones, the playback device may continue playing back content through all of the devices so as not to interrupt the listening experience of others. Moreover, because the wireless charging device can be configured to charge the headphones via another power transmitter (e.g., a mid-field or far-field power transmitter), the headphones are less likely to run out of energy even if the headphones are not within range of the near-field power transmitter. In the event that the playback device stopped playing back content when the headphones were removed and the headphones are later brought within the near-field charging threshold of the wireless charging device, the playback device can transfer playback back to the playback device and, optionally, stop playing back content on the headphones. In this manner, the disclosed wireless charging device enables users to seamlessly switch between playback devices, reduces the likelihood that their listening experience will be interrupted by a loss of power, and efficiently provides power via an appropriate power transmitter depending on the environment and the relationship between the wireless charging device and compatible devices. Thus, the disclosed wireless charging device provides significant advantages over conventional charging devices.

As another example, playback parameters of the audio and/or a playback device may be adjusted before, during, or after transition from one power transmission modality to another. For example, because far-field power transmission can be less efficient than near-field power transmission, playback parameters of the audio or playback device can be adjusted to conserve power when transitioning from a near-field power transmitter to a far-field power transmitter. These adjustments may include reducing playback volume, reducing an amount of bass output, offloading or transferring playback responsibilities to another playback device, offloading or transferring group coordination to another playback device, disabling a microphone of the playback device, placing the playback device in idle mode, placing the playback device in a standalone (non-group) mode (and removing the playback device from a group), disabling the generation of generative media content, and so on. In some cases, a playback system may maintain power profiles for individual users and/or devices that specify, for various power transmission modalities, one or more playback parameter values to use while transmitting power via the corresponding power modality. In this manner, energy can be conserved while still respecting the playback preferences of one or more users. Conversely, when the playback device is brought within a near-field charging range of the wireless charging device, the playback parameters can be re-adjusted to, for example, increase playback volume, increase an amount of bass output, re-assign playback responsibilities to the playback device, re-assign group coordination to the playback device, enable a microphone of the playback device, place the playback device in an active mode, place the playback device in a group (non-standalone) mode (and adding the playback device to a group), enabling the generation of generative media content, and so on.

In some examples, the wireless charging device may receive periodic updates from compatible devices indicating their current energy storage levels. The wireless charging device can be configured to delay power transmission to another device via a less efficient method (e.g., when transitioning from near-field to far-field transmission) until the other device reaches some energy storage threshold (e.g., 90%, 80%, 75%, 50%, 25% battery level) to reduce power consumption. This may be beneficial for a user who is not planning to use the device long enough to completely drain the device of its stored energy. In some cases, a user may override this feature by providing an indication that the user plans to use the device for an extended period of time by, for example, pressing a button on the device or a corresponding control device (e.g., smart phone, tablet, remote control, etc.). In this manner, the use of less efficient power transmission modalities can be delayed or completely avoided if it will not interrupt the user's enjoyment of the device.

In some examples, the wireless charging device may be transmitting power to an energy harvesting-capable device equipped with an energy harvesting component, facility, circuitry, device, etc. As discussed above, energy harvesting is the process of collecting and converting ambient energy sources, such as solar energy, thermal energy, wind energy, kinetic energy, or others, into electrical energy that can be used by electronic devices (e.g., wireless devices). When transmitting power to an energy harvesting-capable device, the wireless charging device can consider the rate at which the energy harvesting-capable device is harvesting energy. For example, if the energy harvesting-capable device is harvesting energy faster than it is using energy, the wireless charging device may stop transmitting power to the energy harvesting-capable device. In some cases, the wireless charging device may periodically request an update from the energy harvesting-capable device to determine the energy harvesting-capable device's current energy level (e.g., battery percentage) and/or energy harvesting rate to determine whether the wireless charging device should begin transmitting power to the energy harvesting-capable device via an appropriate power transmitter if, for example, the energy level and/or energy harvesting rate drops below a predetermined threshold (e.g., 0.25 A, 0.5 A, 1 A, etc.). As another example, the wireless charging device may modulate or otherwise reduce the rate at which power is transmitted to the energy harvesting-capable device to reduce power consumption by the wireless charging device.

In some examples, the wireless charging device may be designed to hold or contain one or more compatible devices, such as specialized base, case, or stand for a playback device. For example, the wireless charging device may be a headphone case or stand that comprises multiple wireless transmission devices, each capable of charging a compatible device via one or more power transmission modalities. In this manner, the compatible devices can be charged while contained or held by the wireless charging device and also while the compatible devices are not contained or held, such as when a user is using the compatible device. As another example, the wireless charging device may comprise a charging cradle that can transmit power to a compatible device both when the compatible device rests in or on the charging cradle and after the compatible device has been removed from the cradle.

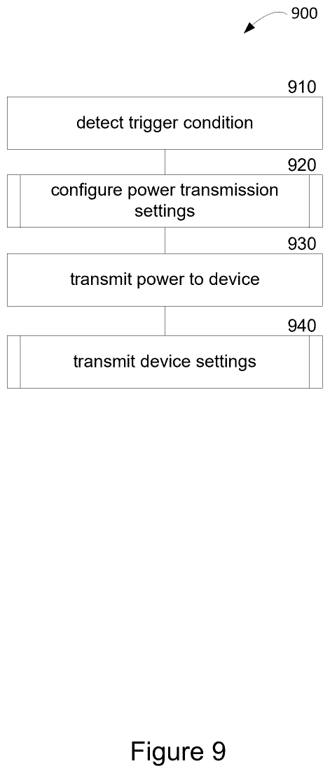

FIGS. 9-11 illustrate example methods in accordance with the present technology. The methods 900, 1000, and 1100 can be implemented by any of the devices described herein, or any other suitable devices now known or later developed. Various embodiments of the methods 900, 1000, and 1100 include one or more operations, functions, or actions illustrated by blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

In addition, for the methods 900, 1000, and 1100 and for other processes and methods disclosed herein, the flowcharts show functionality and operation of possible implementations of some embodiments. In this regard, each block may represent a component, a module, a segment, or a portion of program code, which includes one or more instructions executable by one or more processors on one or more devices for implementing specific logical functions or steps in the process. The program code may be stored on any type of computer readable medium, for example, such as a storage device including a disk or hard drive. The computer readable medium may include non-transitory computer readable media, for example, such as tangible, non-transitory computer-readable media that store data for short periods of time like register memory, processor cache, and Random-Access Memory (RAM). The computer readable medium may also include non-transitory media, such as secondary or persistent long-term storage, like read only memory (ROM), optical or magnetic disks, compact disc read only memory (CD-ROM), for example. The computer readable media may also be any other volatile or non-volatile storage systems. The computer readable medium may be considered a computer readable storage medium, for example, or a tangible storage device. In addition, for the methods and for other processes and methods disclosed herein, each block in FIGS. 9-11 may represent circuitry that is wired to perform the specific logical functions in the process.

In some examples, the methods 900, 1000, and 1100 may be performed via one or more AI models, such as the generative media module(s) discussed above with respect to FIG. 7. In some instances, for example, the methods 900, 1000, and 1100 are executed, partly or wholly, by an AI agent running on one or more devices on a local network (or perhaps via a wide area network). In some examples, the methods 900, 1000, and 1100 are implemented partly or wholly as part of a smart contract, which may be stored and/or executed via a distributed ledger stored locally (e.g., via one or more devices of the media playback system 100 (FIG. 1B)), remotely (e.g., via one or more of the networks 102 (FIG. 1B)), and/or a suitable combination thereof. In some cases, for instance, a decentralized autonomous organization (DAO) implemented on a local network (or perhaps via a wide area network) in accordance with a smart contract may interact with or control individual devices on the network, including charging behavior, schemes, etc. As those of ordinary skill in the art will appreciate, at least one benefit of implementing the methods 900, 1000, and 1100 via AI in combination with a blockchain-based approach is to intelligently automate a control process on the network (e.g., via an AI) using input parameters and/or other data whose provenance has been confirmed or validated via data stored on a distributed ledger, such as a blockchain. Additional details regarding the use of AI models and/or smart contracts with respect to controlling devices and/or generating content can be found in International Patent Application Publication No. WO2023/225448, titled “Generating Digital Media Based on Blockchain Data,” which is herein incorporated by reference in its entirety.

FIG. 9 illustrates a method 900 for configuring a wireless charging device to transmit power to a compatible device via an appropriate power transmission modality in accordance with examples of the present technology.

The method 900 begins in block 910 with detecting a trigger condition such as a change in a compatible device, such as a playback device that has moved within a predetermined distance from the wireless charging device, a wireless charging device that has moved within a predetermined distance from a playback device, a wireless charging device being turned on or becomes available in the vicinity of the playback device, the battery level of the playback device dropping below a predetermined threshold, a playback device being removed from a cradle or other charging station, a user entering or leaving the vicinity of the playback device, a manual initiations (e.g., voice command or a command from a control device), and so on. As discussed above, the method may include detecting these changes by periodically analyzing the signal strength of wireless power transmission or other communication signals between the wireless charging device and compatible device, periodically determining a time-of-flight measurement between the wireless charging device and the compatible device, periodically analyzing acoustic and/or UWB localization signals transmitted between the devices, periodically analyzing location coordinates (e.g., GPS coordinates), and so on.

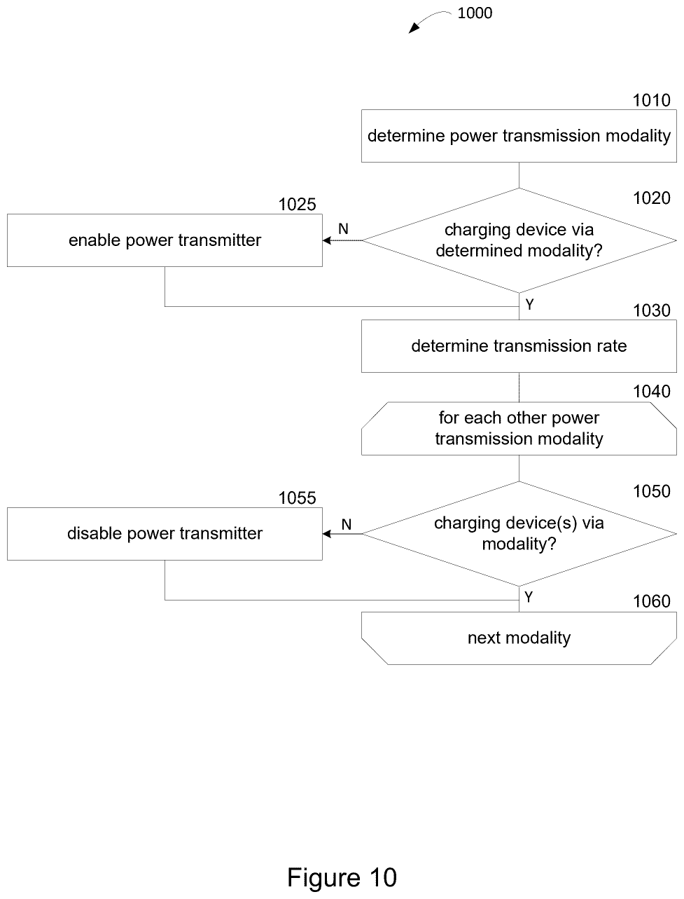

In block 920, the method 900 involves configuring power transmission settings for the wireless charging device and the compatible device, as discussed in further detail below with reference to FIG. 10.

In block 930, the method 900 involves beginning (or continuing) power transmission to the compatible device(s).

In block 940, the method 900 involves transmitting device settings, such as playback settings, group settings, etc. to the compatible device as discussed in further detail below with reference to FIG. 11. One of ordinary skill in the art will recognize that the method 900 may be performed repeatedly in response to changes in the location or proximity of any number of compatible devices relative to the wireless charging device.

FIG. 10 illustrates a method 1000 (which, in some examples, corresponds to block 920 (FIG. 9)) for configuring a wireless charging device to transmit power to a compatible device via an appropriate power transmission modality in accordance with examples of the present technology.

The method 1000 begins in block 1010 with determining a power transmission modality for the compatible device. Determination of the power transmission modality can be based on a determined distance between the wireless charging device and the compatible device. For example, each power transmission modality may have an associated range of effectiveness (e.g., 0-5 cm, 1-3 meters, and so on). Based on the determined distance, the method 1000 can select a power transmission modality that is effective for the determined distance. In the event that multiple power transmission modalities are effective for the determined distance, the method 1000 may select a power transmission modality based which modality consumes the least power, whether or not the modality is already being used to charge a device, the rate at which the modality can transmit power to the compatible device, and so on. Alternatively, the wireless power transmitter may transmit power via multiple power transmission modalities and their associated power transmitters. In the event that the wireless charging device is repeatedly changing power transmission modalities because, for example, a user is carrying the device around, the wireless charging device may select the power transmission with the longest range to prevent frequent (e.g., more than once per minute, once per five minutes, etc.) switches between power transmission modalities. In some cases, the compatible device and/or wireless charging device may be configured to notify a user when the compatible device goes beyond an effective charge range for a power transmission modality, such as via an audible alert, flashing light, etc.

In decision block 1020, if the wireless charging device is already charging a compatible device via the determined power transmission modality, then the method 1000 continues at block 1030, otherwise the method 1000 continues at block 1025.

In block 1025, the method 1000 involves enabling the power transmitter(s) associated with the determined power transmission modalit (ies). In block 1030, the method 1000 determines a power transmission rate for the compatible device based on, for example, the amount of on-board energy remaining on the compatible device, the rate at which an energy harvesting-capable device is harvesting energy for the device, the rate at which the wireless charging device is providing power to other devices, and so on. For example, if the amount of on-board energy on the compatible device is above a predetermined upper threshold (e.g., 50%, 75%, 90%), the method 1000 may determine a low transmission rate, such as a trickle charge rate, or no transmission at all. Conversely, if the amount of on-board energy on the compatible device is below a predetermined lower threshold (e.g., 20%, 25%, 35%), the method 1000 may determine a high transmission rate, such as the maximum rate possible or available for transmitting power to the compatible device via the determined power transmission modality. If the compatible device has an associated energy harvester, the method 1000 may include determining a power transmission rate such that the combined charge rate meets or exceeds some threshold (e.g., 5 μW, 500 μW, 1 mW, 500 mW, 1 W).

In blocks 1040-1060, the method 1000 loops through each of the other power transmission modalities and disables the corresponding power transmitter if it is no longer in use. In decision block 1050, if the currently selected power transmission modality is being used to charge any devices, the method 1000 continues at block 1060, otherwise the method 1000 continues at block 1055. In block 1055, the method 1000 disables the power transmitter associated with the currently selected power transmission modality. In block 1060, if there are any power transmission modalities remaining then the method 1000 selects the next modality and loops back to block 1040, otherwise the method 1000 completes and, in some examples, returns to block 930.

FIG. 11 illustrates a method 1100 (which, in some examples, corresponds to block 940 (FIG. 9)) for transmitting device settings to a compatible device based on a determined power transmission modality. The method 1100 begins in block 1110 with determining playback settings (such as volume settings, equalizer (EQ) settings (e.g., bass, mid-range, upper frequency settings, etc.), generative audio settings, and so on) for the compatible device based on the power transmission modality determined in block 1010. For example, if the power transmission modality is a far-field power transmission modality then the method 1100 may include determining playback settings that will conserve power. Conversely, if the power transmission modality is a near-field power transmission modality then the method 1100 may include determining playback settings that will enhance playback, at the cost of increased power consumption. In block 1120, the method 1100 determines group settings for the compatible device, such as whether the device is to be a group coordinator, whether the device remains in or is to be added to a group, and so on. In block 1130, the method 1100 involves determining power transmission settings for the compatible device, such as whether the compatible device can transmit power to other devices, disabling and/or enabling appropriate wireless power receivers, and so on. For example, if the compatible device is being charged via a far-field power transmission device, the method 1100 may elect to disable wireless power transmission from the compatible device to increase the likelihood that the compatible device remains operational. Although in the examples above the settings determinations were based on whether the selected modality was far-field or near-field, one of ordinary skill in the art will recognize that these settings may be based on other or additional factors, such as the determined power transmission rate, the rate at which the compatible device is being charged, the rate at which the compatible device is consuming power, the rate at which the compatible device is harvesting energy, and so on. In some cases, method 1100 (or parts thereof) may be performed at the compatible device so that some or all of the settings need not be transmitted to the compatible device.

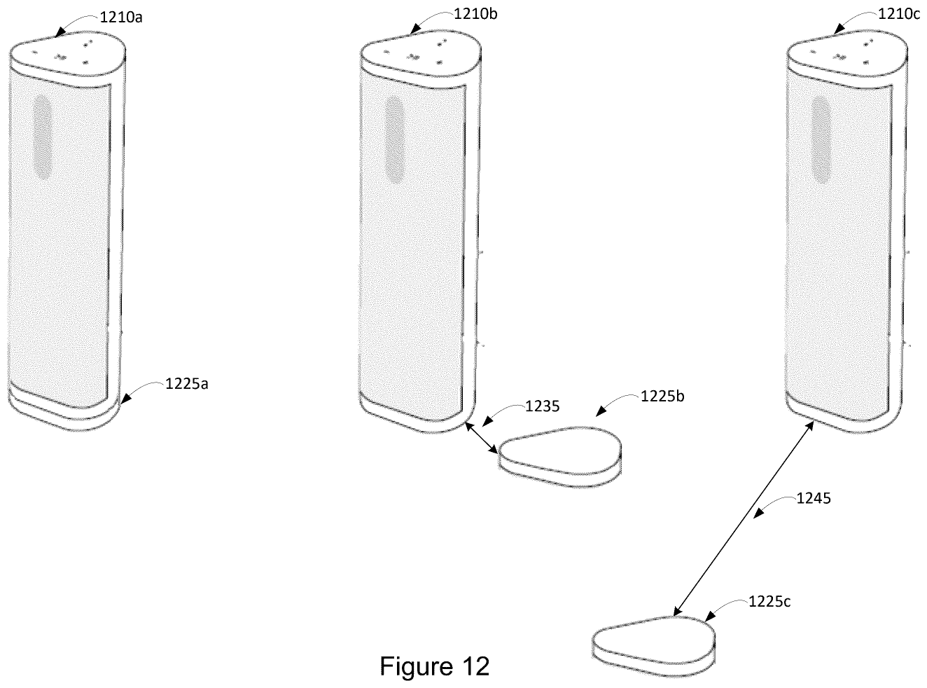

FIG. 12 illustrates several configurations for charging compatible devices using wireless charging devices with multiple power transmitters, each configured transmitter power via one or more power transmission modalities. In this example, three different configurations are shown for transmitting wireless power from wireless charging device 1225 to compatible device 1210 using a near-field power transmission modality and/or a far-field power transmission modality. In the first configuration, compatible device 1210a is resting on wireless charging device 1225a. In this configuration, the wireless charging device 1225a is configured to transmit power to the compatible device 1210a via the near-field power transmission modality and corresponding power transmitter. In the second configuration, compatible device 1210b is near wireless charging device 1225b, but is no longer resting on the wireless charging device 1225b. However, the distance 1235 is less than the effective range for the near-field power transmission modality used by wireless charging device 1225b. Thus, the wireless charging device 1225b is configured to transmit power to the compatible device 1210b via the near-field power transmission modality and corresponding power transmitter. In the third configuration, compatible device 1210c is at a distance 1245 away from wireless charging device 1225c that is greater than the effective range for the near-field power transmission modality used by wireless charging device 1225c. Thus, the wireless charging device 1225c is configured to transmit power to the compatible device 1210c via the far-field power transmission modality used by wireless charging device 1225c. In this example, transitioning from the first or second configuration (or a non-charging configuration) to the third configuration will trigger the wireless charging device to transition from the near-field power transmission modality to the far-field power transmission modality and corresponding power transmitter. Conversely, transitioning from the third configuration (or a non-charging configuration) to the first or second configurations will trigger the wireless charging device to transition from the far-field power transmission modality to the near-field power transmission modality. One of ordinary skill in the art will recognize that a wireless charging device may include more than two power transmitters and be able to transmit power to compatible devices via more than two power transmission modalities.

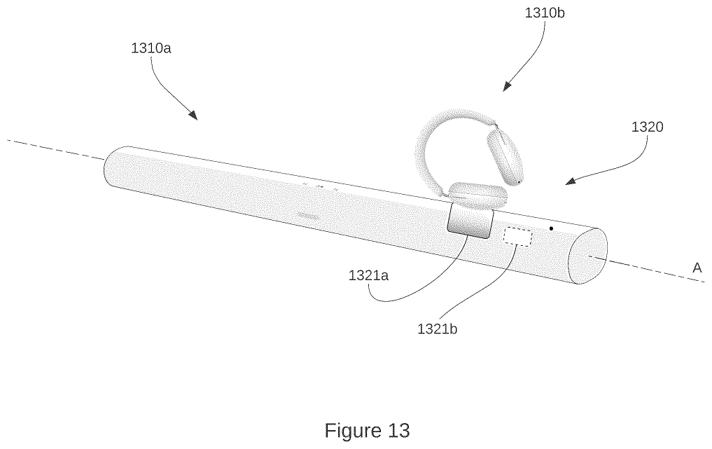

FIG. 13 is a partially schematic diagram illustrating a charging device (e.g., the wireless charging device 700 of FIG. 7) that is integrated into another device, such as a playback device (e.g., the device 810 of FIG. 8). In the illustrated example, a first playback device 1310a (e.g., a soundbar, a home theater device such as the playback device 110h (FIGS. 1J and 1K) and/or another playback device) includes an integrated charging system or device 1320 that includes a first wireless charging transmitter 1321a (e.g., an in-contact and/or near-field wireless charging transmitter, such as Qi or Qi2 charger) and a second wireless charging transmitter 1321b (e.g., a far-field wireless charging transmitter). A second playback device 1320b (e.g., a headphone or another wearable device, a portable playback device) can be placed in contact with or directly adjacent (e.g., within about 5 cm) the first wireless charging transmitter 1321a to recharge an on-board energy storage, such as a battery. In some examples, the second playback device 1320b is an over-car wearable device (e.g., an over-ear headphone, an extended reality device) that includes one or more wireless power receivers (e.g., coils and corresponding electronics) disposed in one or both carcups.

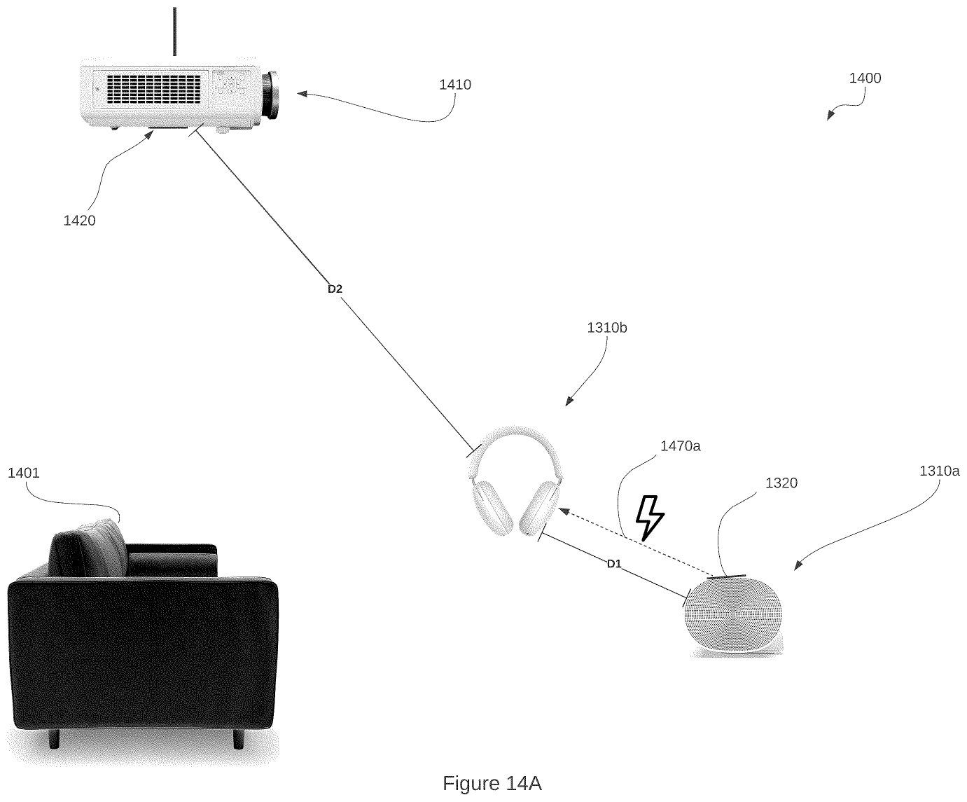

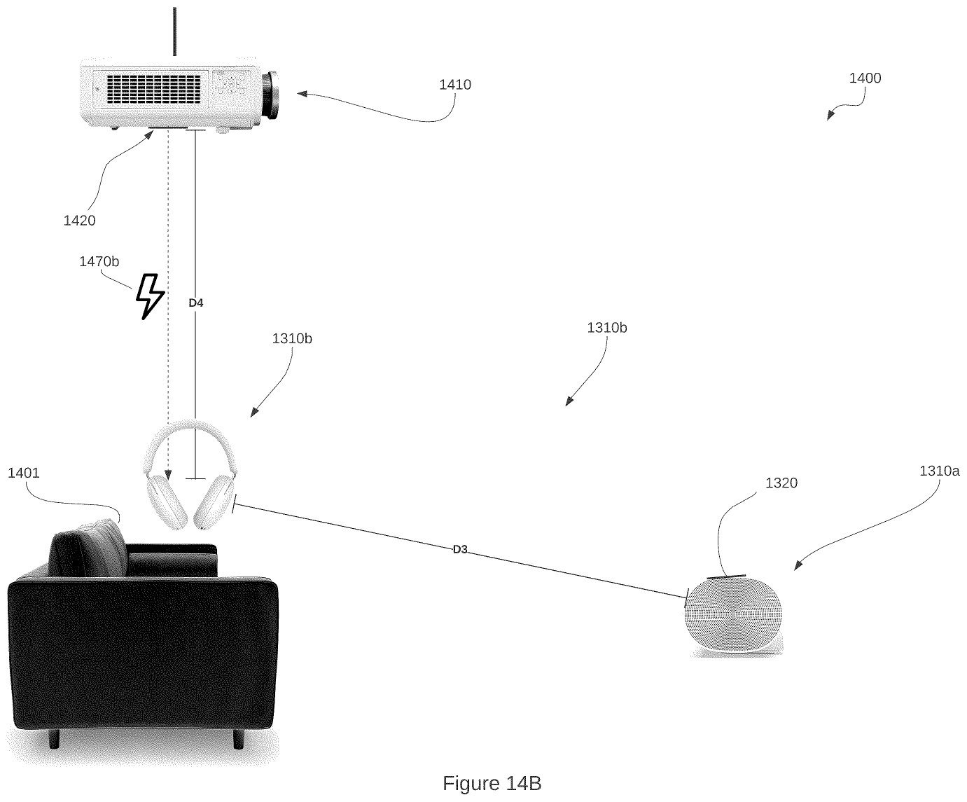

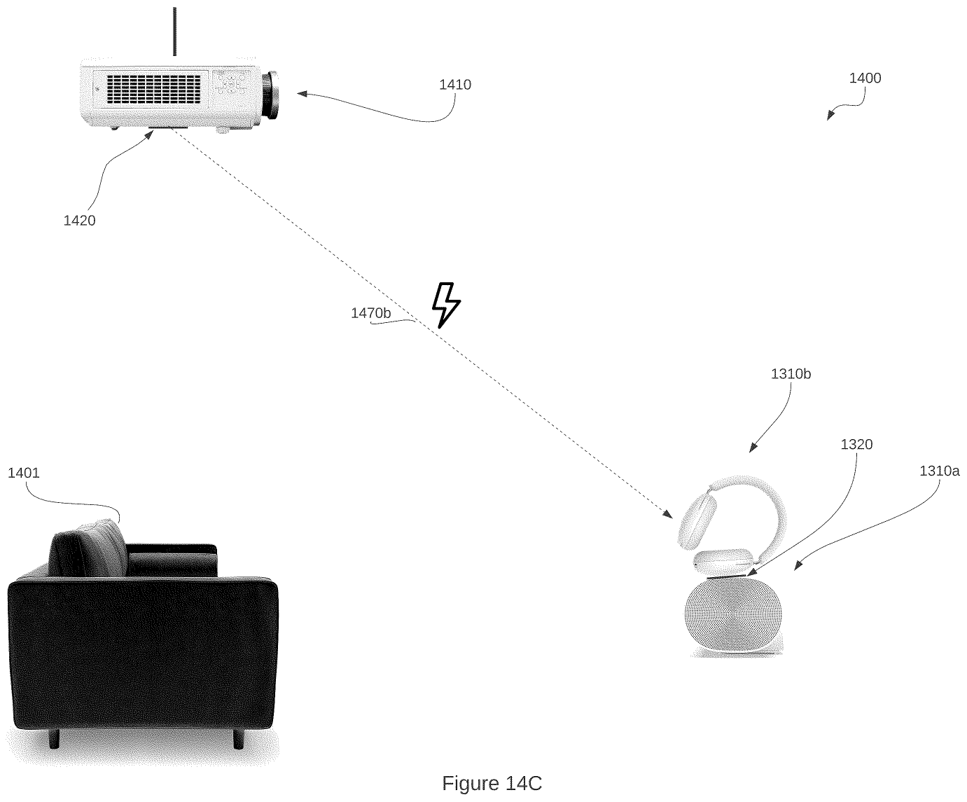

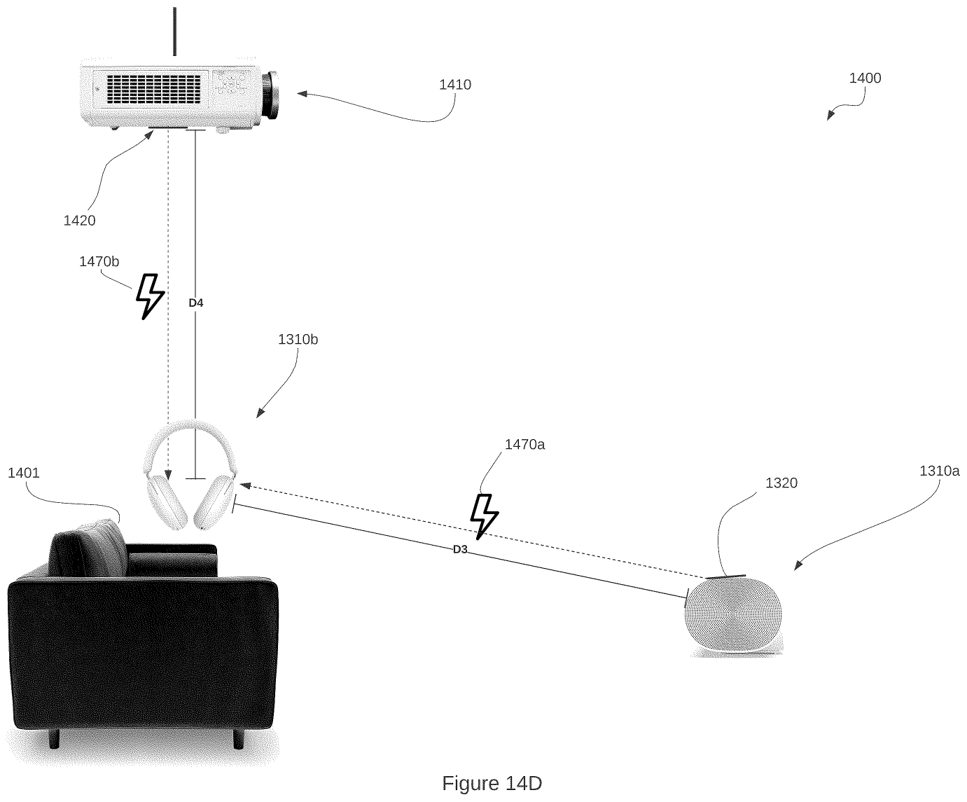

FIGS. 14A-14D are partially schematic diagrams of a side view of the first playback device 1310a shown along the axis A (FIG. 13) and positioned in a listening environment 1400 (e.g., a home theater, a living room, a den, a commercial or retail environment). A sitting area or a couch 1401 is near and/or under a device 1410 (e.g., a display device such as a projector, a ceiling mounted playback device, and/or a light fixture) with an integrated wireless charging transmitter 1420 (e.g., a far-field wireless transmitter).

In the illustrated example of FIG. 14A, the second playback device 1320b is positioned a first distance D1 (e.g., 1m) from the second wireless charging transmitter 1321b (rather than in contact with or directly adjacent to the first wireless charging transmitter 1321a (FIG. 13)) and positioned a greater, second distance D2 (e.g., 2m) from the device 1410. In some examples, the distances D1 and D2 can be determined via one or more techniques described in U.S. Pat. No. 11,809,782, incorporated by reference above. In some examples, one or more other suitable distance determination techniques. In certain examples, the distances D1 and/or D2 (or perhaps a comparison of the distances) can be inferred by relative signal strengths of far-field wireless power signals emitted via the second wireless charging transmitter 1321b and the wireless charging transmitter 1420.

The second wireless charging transmitter 1321b provides a far-field wireless power transmission 1470a to the second playback device 1320b to recharge an onboard energy storage. In some examples, a transition from in-contact/near-field charging to far-field charging between the second playback device 1310b and the integrated charging device 1320 (as a result, for instance, of moving the second playback device 1310b away from the first playback device 1310) serves as a trigger condition for a corresponding audio playback operation. In some instances, for example, the audio playback operation may comprise the second playback device 1310b joining (or perhaps re-joining) a synchrony group that includes the first playback device 1310a. In some instances, for example, the audio playback operations may include swapping audio playback from the first playback device 1310a to the second playback device 1310b. Additional details regarding transitioning a playback session between playback devices can be found, for example, in U.S. Pat. No. 11,356,777 entitled, “Playback Transitions,” which is herein incorporated by reference in its entirety.

In some examples, far-field charging transitions from a first wireless charging transmission to another device capable of near-field and/or far-field wireless charging transmission. In the illustrated example of 14B, for instance, the second playback device 1310b has moved closer to the device 1410 than the first playback device 1310a such that a fourth distance D4 (e.g., approximately 1.5m) is less than a third distance D3 (e.g., approximately 2.5m). As a result, handoff of far-field wireless power transmission is transitioned from the second wireless charging transmitter 1321b and the wireless charging transmitter 1420. As a result, the wireless charging transmitter 1420 provides a second far-field wireless power transmission 1470b and the second wireless charging transmitter 1321b ceases transmission of the first wireless power transmission 1470a.

In some examples, the determination of handoff is performed by the first playback device 1310a in coordination with the device 1410. Referring still to FIG. 14B, the first playback device 1310a may receive an indication (e.g., via the network interface) that the second playback device 1310b has moved closer to another device (e.g., the device 1410) capable of wireless charging. In some cases, the indication is received via the second playback device 1310b, the device 1410, and/or one or more other devices associated with the media playback system (e.g., the system 100 of FIGS. 1A and 1B). In response to receiving the indication, wireless charging transmission transitions from the first playback device 1310a to from the device 1410. In other examples, the transitioning occurs via an indication received via the second charging device (e.g., the device 1410) rather than the original charging device (e.g., the first playback device 1310a). In some examples, the device being wirelessly charged (e.g., the second playback device 1310b) handles a portion or all of the coordination of transitioning charging from the first playback device 1310a to the device 1410.

In some examples, a device can receive wireless charging transmissions from multiple charging devices according to different wireless charging modalities. In the illustrated example of FIG. 14C, for instance, the second playback device 1310 receives first wireless charging transmission via a first modality (e.g., in-contact or near-field charging) from the first playback device 1310a and a second wireless charging transmission via a second modality (e.g., far-field charging) from the device 1410. In some examples, the second carcup of the second playback device 1310b receives far-field wireless power while the first carcup receives in-contact near-field wireless charging.

In some examples, a device receives wireless charging transmissions from multiple charging devices according to the same wireless charging modality. In the illustrated example of FIG. 14D, for instance, the second playback device 1310b concurrently receives the first wireless charging transmission 1470a from the first playback device 1310a and the second wireless charging transmission 1470b from the device 1410. In some examples, the second playback device 1310b receives the multiple transmissions via a single receiver. In other examples, the second playback device 1310b receives the multiple transmissions via multiple receivers (e.g., receivers integrated into each of the carcups).

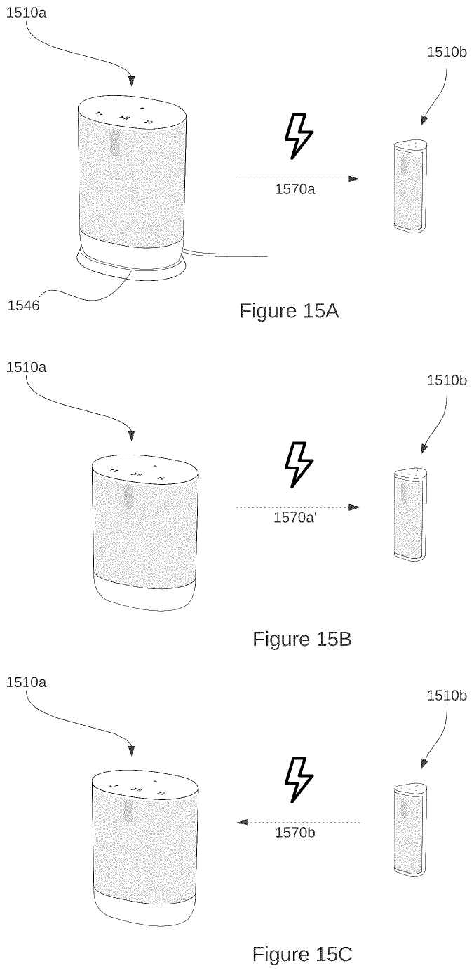

In some examples, devices with on-board energy storage (e.g., batteries, capacitors) can charge one another. FIGS. 15A-15C are schematic diagrams of a first playback device 1510a (e.g., a device similar to Sonos Move or another battery-powered portable device (or perhaps a corded device with on-board energy storage)) and a second playback device 1510b (e.g., a device similar to Sonos Roam or another portable playback device, a wearable playback device) capable of wireless power transmission and/or receiving. In illustrated example of FIG. 15A, a dock 1546 (e.g., a charging dock similar to the dock 246 of FIG. 2D and/or a smart dock) provides power to the first playback device 1510a. The second playback device 1510b receives wireless power transmission 1570a having a first signal strength (e.g., 1 W, 2 W, 5 W) via the first playback device 1510a and/or the dock 1546. If the first playback device 1510a is removed from the dock 1546 (FIG. 15B), wireless power transmission 1570a′ is adjusted to a lesser, second signal strength (e.g., 1 W or less) to conserve battery power on the first playback device 1510a. In some examples, the devices can swap charging roles such that the second playback device 1510b provides wireless power transmission 1570b (FIG. 15C) to the first playback device 1510a based on, for instance, the relative amount of stored energy (e.g., battery levels) on the two devices. In some examples, the first playback device 1510a and second playback device 1510b exchange battery information (e.g., battery charge level, battery characteristics such as age, temperature, charge cycles) such that the individual devices aim for a homeostasis condition, which may be dynamic as the power consumption rates of the individual devices may differ over time based on operation conditions such as output volume, frequency content (e.g., amount of bass), temperature, network parameters, etc.

In the illustrated examples described above, the devices may be shown as audio playback devices. In some examples, however, one or more of the devices may comprise other types of devices including smartphones, tablets, video display devices (e.g., televisions), medical devices, implantable devices, remote controls, internet of things (IoT) devices such as sensors, cameras, microphones, thermostats, light sources, smart doorbells, etc.

### VI. Conclusion

The above discussions relating to wireless power transfer devices, playback devices, controller devices, playback zone configurations, and media/audio content sources provide only some examples of operating environments within which functions and methods described below may be implemented. Other operating environments and configurations of wireless power transfer systems, media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory media such as a memory, DVD, CD, Blu-ray, and so on, storing the software and/or firmware.

The present technology is illustrated, for example, according to various aspects described below. Various examples of aspects of the present technology are described as numbered examples for convenience. These are provided as examples and do not limit the present technology. It is noted that any of the dependent examples may be combined in any combination, and placed into a respective independent example. The other examples can be presented in a similar manner. Example 1: A media playback system comprising: a playback device comprising: an energy storage device, a first wireless power receiver, and a second wireless power receiver; a charging device comprising: a first power transmitter configured to transmit power to the playback device via the first wireless power receiver when the playback device and the charging device are in a first power configuration, wherein in the first power configuration the playback device is within a threshold distance from the charging device, and a second power transmitter configured to transmit power to the playback device via the second wireless power receiver when the playback device is in a second power configuration, wherein in the second power configuration the playback device is beyond the threshold distance from the charging device; and a computer-readable memory storing instructions that, when executed by one or more processors, cause the media playback system to perform operations comprising: determining when the playback device and the charging device have switched power configurations, after determining that the playback device and the charging device have switched to the first power configuration, configuring the playback device to receive power from the charging device via the first wireless power receiver, configuring the charging device to transmit power to the playback device via the first power transmitter, and adjusting at least one playback parameter and/or grouping parameter of the playback device for playback in a first charging mode, and after determining that the playback device and the charging device have switched to the second power configuration, configuring the playback device to receive power from the charging device via the second wireless power receiver, configuring the charging device to transmit power to the playback device via the second power transmitter, and adjusting at least one playback parameter and/or grouping parameter of the playback device for playback in a second charging mode.

Example 2: The media playback system of any one of the preceding Examples, wherein the playback device further comprises an energy harvester system, the operations further comprising: when the playback device and the charging device are in the second power configuration, determining a rate at which the energy harvester system is harvesting energy, and modulating power transmitted to the playback device via the second power transmitter based on the determined rate at which the energy harvester system is harvesting energy.

Example 3: The media playback system of any one of the preceding Examples, wherein the charging device comprises a base, case, or stand configured to engage with the playback device.

Example 4: The media playback system of any one of the Examples, wherein the first power transmitter comprises an in-contact power transmitter or a near-field power transmitter.

Example 5. The media playback system of any one of the preceding Examples, wherein the second power transmitter transmits power via optical electromagnetic transmission, WiFi transmission, sonic transmission, radio frequency (RF) transmission, thermal energy transmission, or magnetic resonance.

Example 6. The media playback system of any one of the preceding Examples, wherein adjusting at least one playback parameter and/or grouping parameter of the playback device for playback in the second charging mode includes modifying operation of the playback device to reduce power consumption.

Example 7. The media playback system of any one of the preceding Examples, wherein adjusting at least one playback parameter and/or grouping parameter of the playback device for playback in the second charging mode includes placing the playback device in a standalone mode.

Example 8. The media playback system of any one of the preceding Examples, wherein adjusting at least one playback parameter and/or grouping parameter of the playback device comprises: reducing an amount of bass output, reducing playback volume, offloading playback responsibilities to another playback device, offloading group coordination to another playback device, disabling a microphone of the playback device, or placing the playback device in idle mode.

Example 9. The media playback system of any one of the preceding Examples, wherein determining when the playback device and the charging device have switched power configurations comprises: determining a distance between the playback device and the charging device; and comparing the determined distance to the threshold distance.

Example 10. The media playback system of any one of the preceding Examples, wherein the playback device further comprises an energy harvester system and wherein determining when the playback device and the charging device have switched power configurations further comprises: determining a rate at which the energy harvester system is harvesting energy; and comparing the determined rate at which the energy harvester system is harvesting energy to a predetermined threshold.

Example 11. A charging device, comprising: a first power transmitter; a second power transmitter; and computer-readable memory storing instructions that, when executed by one or more processors, cause the charging device to perform operations comprising: transmitting, via the first power transmitter, power to a first target device according to a first power transmission modality, detecting that the first target device has moved a first distance away from the first power transmitter, wherein the first distance exceeds a predetermined threshold distance, and after detecting that the first target device has moved the first distance away from the first power transmitter, transitioning from transmitting power to the first target device via the first power transmitter to transmitting power to the first target device via the second power transmitter, wherein the transitioning includes ceasing transmitting via the first power transmitter and initiating transmitting via the second power transmitter.

Example 12. The charging device of any one of the preceding Examples, wherein the first target device comprises a portable playback device.

Example 13. The charging device of any one of the preceding Examples, wherein the first target device comprises a wearable or implantable device.

Example 14. The charging device of any one of the preceding Examples, wherein the first target device comprises an energy harvester, the operations further comprising: receiving, from the first target device, a rate at which the energy harvester is harvesting energy; and modulating power transmitted to the first target device based on the rate at which the energy harvester is harvesting energy.

Example 15. The charging device of any one of the preceding Examples, further comprising a base, case, or stand configured to engage with the first target device.

Example 16. The charging device of any one of the preceding Examples, wherein the first power transmitter comprises an in-contact power transmitter or a near-field power transmitter.

Example 17. The charging device of any one of the preceding Examples, wherein the second power transmitter transmits power via optical electromagnetic transmission, WiFi transmission, sonic transmission, radio frequency (RF) transmission, thermal energy transmission, or magnetic resonance.

Example 18. The charging device of any one of the preceding Examples, wherein detecting that the first target device has moved a first distance away from the first power transmitter comprises at least one of: determining a signal strength of wireless power transmission between the first target device and the first power transmitter; determining a time-of-flight measurement between the first target device and the first power transmitter; or analyzing acoustic localization signals transmitted between the first target device and the first power transmitter.

Example 19. The charging device of any one of the preceding Examples, the operations further comprising: detecting that the first target device has moved to within the first distance away from the first power transmitter; and after detecting that the first target device has moved to within the first distance away from the first power transmitter, re-transitioning from transmitting power to the first target device via the second power transmitter to transmitting power to the first target device via the first power transmitter.

Example 20. The charging device of any one of the preceding Examples, wherein the re-transitioning includes ceasing transmitting via the second power transmitter and initiating transmitting via the first power transmitter.

Example 21. A first playback device, comprising: one or more audio transducers; a network interface; a near-field power transmitter; and computer-readable memory storing instructions that, when executed by one or more processors, cause the first playback device to perform operations comprising: receiving media content, playing back, via the one or more audio transducers, first audio corresponding to the media content, transmitting, via the near-field power transmitter, power to a second playback device, wherein transmitting power to the second playback device comprises activating the near-field power transmitter, detecting that the second playback device has moved a threshold distance from the near-field power transmitter, and after detecting that the second playback device has moved the threshold distance from the near-field power transmitter, deactivating the near-field power transmitter, and transitioning, via the network interface, playback of the first audio from via the one or more audio transducers to via the second playback device.

Example 22. The first playback device of any one of the preceding Examples, further comprising a far-field power transmitter, wherein the operations further comprise, after transitioning playback of the first audio to via the second playback device, transmitting power to the second playback device via the far-field power transmitter.

Example 23. The first playback device of any one of the preceding Examples, the operations further comprising: detecting that the second playback device has moved to within the threshold distance from the near-field power transmitter; and after detecting that the second playback device has moved to within the threshold distance from the near-field power transmitter, deactivating the far-field power transmitter, activating the near-field power transmitter, and transitioning, via the network interface, playback of the first audio from via the second playback device to via the one or more audio transducers.

Example 24. The first playback device of any one of the preceding Examples, the operations further comprising: after detecting that the second playback device has moved to within the threshold distance from the near-field power transmitter, adjusting at least one playback parameter of the first audio for playback via the one or more audio transducers.

Example 25. The first playback device of any one of the preceding Examples, the operations further comprising: after detecting that the second playback device has moved the threshold distance from the near-field power transmitter, adjusting at least one playback parameter of the first audio for playback via the second playback device.

Example 26. The first playback device of any one of the preceding Examples, wherein the second playback device comprises a portable playback device.

Example 27. The first playback device of any one of the preceding Examples, wherein the second playback device comprises a wearable or implantable device.

Example 28. The first playback device of any one of the preceding Examples, wherein the second playback device comprises an energy harvester, the operations further comprising: while transmitting, via the near-field power transmitter, power to the second playback device, receiving, from the second playback device, a rate at which the energy harvester is harvesting energy, and modulating power transmitted, via the near-field power transmitter, to the second playback device, via the near-field power transmitter, based on the rate at which the energy harvester is harvesting energy.

Example 29. The first playback device of any one of the preceding Examples, further comprising a base, case, or stand configured to engage with the second playback device.

Example 30. The first playback device of any one of the preceding Examples, wherein the first playback device and the second playback device each belong to a first playback group, the operations further comprising: after detecting that the second playback device has ceased receiving power, removing the second playback device from the first playback group.

1. A media playback system comprising:
a playback device comprising:
an energy storage device,
a first wireless power receiver, and
a second wireless power receiver;
a charging device comprising:
a first power transmitter configured to transmit power to the playback device via the first wireless power receiver when the playback device and the charging device are in a first power configuration, wherein in the first power configuration the playback device is within a threshold distance from the charging device, and
a second power transmitter configured to transmit power to the playback device via the second wireless power receiver when the playback device is in a second power configuration, wherein in the second power configuration the playback device is beyond the threshold distance from the charging device; and
a computer-readable memory storing instructions that, when executed by one or more processors, cause the media playback system to perform operations comprising:
determining when the playback device and the charging device have switched power configurations,
after determining that the playback device and the charging device have switched to the first power configuration,
configuring the playback device to receive power from the charging device via the first wireless power receiver,
configuring the charging device to transmit power to the playback device via the first power transmitter, and
adjusting at least one playback parameter and/or grouping parameter of the playback device for playback in a first charging mode, and
after determining that the playback device and the charging device have switched to the second power configuration,
configuring the playback device to receive power from the charging device via the second wireless power receiver,
configuring the charging device to transmit power to the playback device via the second power transmitter, and
adjusting at least one playback parameter and/or grouping parameter of the playback device for playback in a second charging mode.

2. The media playback system of claim 1, wherein the playback device further comprises an energy harvester system, the operations further comprising:
when the playback device and the charging device are in the second power configuration, determining a rate at which the energy harvester system is harvesting energy, and
modulating power transmitted to the playback device via the second power transmitter based on the determined rate at which the energy harvester system is harvesting energy.

3. The media playback system of claim 1, wherein the charging device comprises a base, case, or stand configured to engage with the playback device.

4. The media playback system of claim 1, wherein the first power transmitter comprises an in-contact power transmitter or a near-field power transmitter.

5. The media playback system of claim 1, wherein the second power transmitter transmits power via optical electromagnetic transmission, WiFi transmission, sonic transmission, radio frequency (RF) transmission, thermal energy transmission, or magnetic resonance.

6. The media playback system of claim 1, wherein adjusting at least one playback parameter and/or grouping parameter of the playback device for playback in the second charging mode includes modifying operation of the playback device to reduce power consumption.

7. The media playback system of claim 1, wherein adjusting at least one playback parameter and/or grouping parameter of the playback device for playback in the second charging mode includes placing the playback device in a standalone mode.

8. The media playback system of claim 1, wherein adjusting at least one playback parameter and/or grouping parameter of the playback device comprises: reducing an amount of bass output, reducing playback volume, offloading playback responsibilities to another playback device, offloading group coordination to another playback device, disabling a microphone of the playback device, or placing the playback device in idle mode.

9. The media playback system of claim 1, wherein determining when the playback device and the charging device have switched power configurations comprises:
determining a distance between the playback device and the charging device; and
comparing the determined distance to the threshold distance.

10. The media playback system of claim 9, wherein the playback device further comprises an energy harvester system and wherein determining when the playback device and the charging device have switched power configurations further comprises:
determining a rate at which the energy harvester system is harvesting energy; and
comparing the determined rate at which the energy harvester system is harvesting energy to a predetermined threshold.

11. A charging device, comprising:
a first power transmitter;
a second power transmitter; and
computer-readable memory storing instructions that, when executed by one or more processors, cause the charging device to perform operations comprising:
transmitting, via the first power transmitter, power to a first target device according to a first power transmission modality,
detecting that the first target device has moved a first distance away from the first power transmitter, wherein the first distance exceeds a predetermined threshold distance, and
after detecting that the first target device has moved the first distance away from the first power transmitter, transitioning from transmitting power to the first target device via the first power transmitter to transmitting power to the first target device via the second power transmitter,
wherein the transitioning includes ceasing transmitting via the first power transmitter and initiating transmitting via the second power transmitter.

12. The charging device of claim 11, wherein the first target device comprises a portable playback device, a wearable device, and/or an implantable device.

13. The charging device of claim 11, wherein the first target device comprises an energy harvester, the operations further comprising:
receiving, from the first target device, a rate at which the energy harvester is harvesting energy; and
modulating power transmitted to the first target device based on the rate at which the energy harvester is harvesting energy.

14. The charging device of claim 11, wherein detecting that the first target device has moved a first distance away from the first power transmitter comprises at least one of:
determining a signal strength of wireless power transmission between the first target device and the first power transmitter;
determining a time-of-flight measurement between the first target device and the first power transmitter; or
analyzing acoustic localization signals transmitted between the first target device and the first power transmitter.

15. The charging device of claim 11, the operations further comprising:
detecting that the first target device has moved to within the first distance away from the first power transmitter; and
after detecting that the first target device has moved to within the first distance away from the first power transmitter, re-transitioning from transmitting power to the first target device via the second power transmitter to transmitting power to the first target device via the first power transmitter, wherein the re-transitioning includes ceasing transmitting via the second power transmitter and initiating transmitting via the first power transmitter.

16. A first playback device, comprising:
one or more audio transducers;
a network interface;
a near-field power transmitter; and
computer-readable memory storing instructions that, when executed by one or more processors, cause the first playback device to perform operations comprising:
receiving media content,
playing back, via the one or more audio transducers, first audio corresponding to the media content,
transmitting, via the near-field power transmitter, power to a second playback device, wherein transmitting power to the second playback device comprises activating the near-field power transmitter,
detecting that the second playback device has moved a threshold distance from the near-field power transmitter, and
after detecting that the second playback device has moved the threshold distance from the near-field power transmitter,
deactivating the near-field power transmitter, and
transitioning, via the network interface, playback of the first audio from via the one or more audio transducers to via the second playback device.

17. The first playback device of claim 16, further comprising a far-field power transmitter, wherein the operations further comprise, after transitioning playback of the first audio to via the second playback device, transmitting power to the second playback device via the far-field power transmitter.

18. The first playback device of claim 17, the operations further comprising:
detecting that the second playback device has moved to within the threshold distance from the near-field power transmitter; and
after detecting that the second playback device has moved to within the threshold distance from the near-field power transmitter,
deactivating the far-field power transmitter,
activating the near-field power transmitter, and
transitioning, via the network interface, playback of the first audio from via the second playback device to via the one or more audio transducers,
adjusting at least one playback parameter of the first audio for playback via the one or more audio transducers.

19. The first playback device of claim 16, wherein the second playback device comprises a portable playback device, a wearable device, and/or an implantable device.

20. The first playback device of claim 16, wherein the second playback device comprises an energy harvester, the operations further comprising:
while transmitting, via the near-field power transmitter, power to the second playback device,
receiving, from the second playback device, a rate at which the energy harvester is harvesting energy, and
modulating power transmitted, via the near-field power transmitter, to the second playback device, via the near-field power transmitter, based on the rate at which the energy harvester is harvesting energy.
